(19) United States
(12) Patent Application Publication
(10) Pub. No.: US 2023/0354242 A1
(43) Pub. Date: Nov. 2, 2023

(54) Methods and Apparatus Relating to Communication of Path Switching Capability Information Between a Network Device and a UE device To Enable Efficient Switching of Multi-Access (MA) Traffic Between Non-3GPP Access Paths

(71) Applicant: Charter Communications Operating, LLC, St. Louis, MO (US)

(72) Inventors: Paul L. Russell, JR., Lawrence, NJ (US); Umamaheswar Kakinada, Greenwood Village, CO (US); Yildirim Sahin, Englewood, CO (US)

(21) Appl. No.: 18/085,548

(22) Filed: Dec. 20, 2022

Related U.S. Application Data
(60) Provisional application No. 63/423,702, filed on Nov. 8, 2022.
(60) Provisional application No. 63/336,213, filed on Apr. 28, 2022.

(51) Int. Cl. H04W 60/04; H04W 8/22; H04W 76/10

(52) U.S. Cl. CPC H04W 60/04; H04W 8/22; H04W 76/10

(57) ABSTRACT

Methods and apparatus for supporting efficient switching of data paths corresponding to a communications session between different non-3GPP access networks, e.g., networks including WiFi access points, using network core functionality are described. A novel registration process in which UE and AMF capability information is exchanged at an early stage in the registration process is described. An initial registration request message from a UE, via a 3GPP or N3GPP access network, includes an indicator as to whether or not the UE supports path switching for MA PDU sessions between N3GPP access paths. This allows, for a UE which supports the path switching, a AMF to be selected and assigned to the UE, which also supports the path switching, thus matching capabilities and eliminating the need for interrupting communications to change AMFs at a later point.

### RELATED APPLICATIONS

The present application claims benefit of U.S. Provisional patent application Ser. No. 63/423,702 which was filed Nov. 8, 2022 and also claims the benefit of U.S. Provisional patent application Ser. No. 63/336,213 filed Apr. 28, 2022 both of which are hereby expressly incorporated by reference.

### FIELD

The present application relates to supporting communications using multiple networks and, more particularly, to exchanging capability information between a UE and 5GC to support efficient switching of traffic corresponding to a communications session between network access paths, e.g., between multiple non-3GPP (N3GPP) access paths such as access paths which use WiFi access points of different networks.

### BACKGROUND

The 5G System architecture is designed to support wide variety of connectivity networks, including both wireline or wireless access networks. 3GPP Rel-18 has a study item related to data path switching between two non-3GPP access paths.

A key problem is how to support switching of traffic of a Multi-Access Protocol Data Unit (MA PDU) Session between two non-3GPP access paths. In particular there is a need for methods and apparatus that would allow a UE to register to 5GC and support switching the traffic from the UE from one non-3GPP access path to another non-3GPP access path.

Potential procedures relating to supporting data path switching between two non-3GPP access paths are proposed in 3GPP TR 23.700-53 V0.2.0 (2022 April) clause 6.7, clause 6.9 and 6.10.

The process discussed in clause 6.9 specifies how the data traffic of an MA PDU Session to be switched between two non-3GPP access paths, both of them using the same PLMN. The described process of TR 23.700-53 clause 6.9 uses the following principles to switch the data traffic of an MA PDU Session between two Non-3GPP access paths:
a. UE uses existing procedures to register to 5GC via a Non-3GPP access network (e.g., an untrusted Non-3GPP access network). Optionally, the UE may also register to 5GC via a 3GPP access network (e.g., via NG-RAN).
b. MA PDU Session is established using the existing procedures specified in 3GPP TS 23.502 V17.4.0 (2022 March), clause 4.22.2, and data traffic is transferred over the paths of the MA PDU Session.
c. UE discovers a new Non-3GPP access network (e.g., a trusted Non-3GPP access networks) and registers to 5GC via this access network with a new Registration Type=“Non-3GPP path switch”. This allows the AMF to maintain temporarily two registrations via two non-3GPP accesses until the path switch is completed.
d. UE initiates the path switch by sending, via the new Non-3GPP access network, an MA PDU Session Establishment Request (using the same PDU session ID), which triggers the SMF to establish user-plane resources for the MA PDU Session over the new Non-3GPP access network.
e. When the user-plane resources for the MA PDU Session over the new Non-3GPP access network are established, the SMF triggers the AMF to deregister the UE from the old Non-3GPP access network (e.g., the untrusted Non-3GPP access network).
f. When the UE triggers the path switching procedure is based on UE implementation.

FIG. 1, comprising the combination of FIG. 1A and FIG. 1B. FIG. 1 is a drawing which includes the steps 100 shown in FIG. 1A and the steps 101 shown in FIG. 1B. FIG. 1 which depicts steps of the path switching process, which enables the data traffic of an MA PDU Session to be switched from a non-3GPP access path using a N3IWF to a non-3GPP access path using a TNGF. The same steps can be used to switch the data traffic of an MA PDU Session between any non-3GPP access paths (using either N3IWF or TNGF). Drawing 100 includes a User Equipment (UE) 102, a non-3GPP Radio Access Network (NG-RAN) 104, an Access and Mobility Management Function (AMF) 106, a User Data Management (UDM) 108, a Session Management Function (SMF) 110, a Non-3GPP Interworking Function (N3IWF) 112, and a Trusted Network Gateway Function (TNGF) 114.

The procedure shown in drawing 100 of FIG. 1 includes the following steps: step 1, step 2, step 3, step 4, step 5, step 6, step 7, step 8, and step 9. Each of the steps (step 1, step 2, step 3, step 4, step 5, step 6, step 7, step 8, step 9) includes one or more operations.

Step 1 will now be described. Optionally, the UE 102 performs an initial 5G registration over 3GPP access in a PLMN. The selected AMF 106 registers with UDM 108 for 3GPP access and provides its GUAMI and RAT type=NR.

Step 2 will now be described. The UE 102 selects an N3IWF and performs an initial 5G registration over untrusted non-3GPP access in the same PLMN. The same AMF is selected, as the one in the previous step. The AMF 106 registers with UDM 108 for non-3GPP access and provides its GUAMI and RAT type=Virtual or WLAN. The AMF 106 may indicate to the UE 102 whether it supports registration for non-3GPP path switch.

Step 3 will now be described. The UE 102 requests an MA PDU Session, as specified in TS 23.502, clause 4.22.2. User-plane resources are established over 3GPP access and over untrusted non-3GPP access. Data traffic over the MA PDU Session is exchanged between the UE and UPF using the two accesses.

Step 3 will now be described in more detail. The UE 102 initiates MA PDU Session establishment and sends a UL NAS Transport message 3a to the AMF 106. The UE NAS Transport message 3a includes PDU Session Id-X, S-NSSAI, DNN, Request Type=MA PDU request, PDU session Est. Request 0. The AMF 106 sends a Create SM Context Request message 3b to the SMF 110. The Create SM Context Request message 3b includes SUPI, PDU Session Id=X, S-NSSAI, DNN, MA Request Indication, AN Type=non-3GPP, Additional AN Type=3GPP, RAT type=Virtual, PDU Session Est. Request 0. The SMF 110 sends a UECM Registration Request message 5c to the UDM 108. The UECM Registration Req. 5c includes PDU Session Id=X, DNN, SUPI, SMF UUID. Additional steps 3d are performed to complete the MA PDU Session establishment and user-plane resources are established over both accesses.

Step 4 will now be described. The UE 102 detects a trusted non-3GPP access network that supports 5G connectivity to the same PLMN. The UE 102 decides to switch the data traffic transferred over the untrusted non-3GPP access of the MA PDU Session to the detected trusted non-3GPP access network. For this purpose, the UE 102 initiates a 5G registration over trusted non-3GPP access and sets the registration type to “Non-3GPP path switch”. This registration type indicates that the registration over trusted non-3GPP access is required for switching the data traffic of an MA PDU Session from one non-3GPP access path to another non-3GPP access path. After the UE 102 is registered via trusted non-3GPP access with registration type “Non-3GPP patch switch”, the AMF 106 does not release the existing registration via untrusted non-3GPP access. The AMF 106 may start a timer and it maintains the two registrations via non-3GPP access until the path switch is completed or until this timer expires. As shown below (see step 9), when the timer expires, the AMF 106 initiates deregistration via the TNGF 114.

Step 5 will now be described. The UE 102 initiates the non-3GPP path switch by requesting user-plane resources via trusted non-3GPP access. To request these user-plane resources, the UE 102 sends a PDU Session Establishment Request in UL NAS Transport 5a via the TNGF 114, which contains request type=MA PDU Request and the identity of the existing MA PDU Session.

The AMF 106 sends an Update SM Context Request 5b to SMF 110, which contains a “Non-3GPP path switch indication”. This indication informs the SMF 110 that the PDU Session Establishment Request is sent to enable path switching from the existing non-3GPP access of the MA PDU Session to a new non-3GPP access. The AMF 106 inserts the “Non-3GPP path switch indication” in the Update SM Context Request 5b because the UE 102 is registered with type “Non-3GPP path switch” (see step 4).

The SMF 110 initiates the user-plane resources establishment over trusted non-3GPP access. Additional steps 5c are performed to complete the user-plane resources establishment over trusted non-3GPP access.

Step 6, which includes steps 6a and 6b will now be described. After user-plane resources over trusted non-3GPP access are established, the UE 102, in step 6a, switches all uplink MA PDU Session traffic from untrusted non-3GPP access to trusted non-3GPP access. Similarly, in step 6b, the UPF switches all downlink MA PDU Session traffic from untrusted non-3GPP access to trusted non-3GPP access (for this the SMF 110 modifies the existing N4 connection).

Step 7 will now be described. The SMF 110 sends an SM Context Status Notify message 7a to AMF 106 to indicate that the non-3GPP path switch has been completed.

Step 8 will now be described. After receiving the SM Context Status Notify message 7a, the AMF 106 updates the UDM 108 with RAT type=Trusted WLAN for non-3GPP access. The AMF 106 initiates deregistration procedure for untrusted Non-3GPP access (see TS 23.502 section 4.12.3). Also, the AMF 106 stops the timer that was started in step 4. After this step, the UE 102 has only one 5G registration via non-3GPP access.

Step 9 will now be described. If the AMF timer started in step 4 expires, the AMF 106 deregisters the UE 102 via trusted non-3GPP access. After this step, the UE 102 has only one 5G registration via non-3GPP access.

The described path switching process has the following impacts on a UE: i) it triggers the switching from one N3GPP path to another N3GPP path is based on UE implementation; and ii) involves use a new Registration Type when performing the switching during the registration procedure via the other non-3GPP path.

The described path switching process has the following impact on a AMF: i) it requires the AMF to indicate to an SMF that non-3GPP path switching is required for the MA PDU session.

The described path switching process has the following impact on a SMF/UPF: it requires the SMF and UPF to: perform the traffic switching from untrusted N3GPP access to trusted N3GPP access or vice versa.

The described path switching process has the following impact on a UDM: The UDM is only expected to be updated with the new RAT type information (e.g., from Virtual/WLAN to Trusted WLAN) after the path switching has been performed successfully.

While the various operations to be performed by an AMF and/or SMF are known from the described process of supporting path switching, some AMFs and/or SMFs may not support the required functions. It should be appreciated that if the AMf/SMF doesn't support non-3GPP path switching and the UE isn't informed until after it attempts to use this capability it may encounter a situation where it needs to de-register from the 1st non-3GPP path prior to establishing the new non-3GPP path. There is a need for methods and/or apparatus for efficiently communicating UE and/or network device capabilities and assigning UE's to devices which support the UE's capabilities. For example, there is a need for efficiently assigning a UE which supports path switching to an AMF and/or SMF which supports such capabilities to reduce the risk of unintentionally interrupted sessions due to lack of path switching support.

### SUMMARY

In various embodiments an AMF provides whether it is capable of supporting non-3GPP path switching, when the UE performs the registration procedure first time with one of the non-3GPP accesses. However, it should be appreciated that a UE may register with the 3GPP access first. In accordance with one feature an AMF provides its capability supporting non-3GPP path switching to the UE regardless the access type where it performs registration.

In various embodiments when the UE performs a registration procedure for the first time (e.g., using a registration message of an initial type) with an AMF, the UE indicates to AMF whether it is capable of supporting non-3GPP path switching.

This is different from previous approaches where such information was not provided to the AMF as part of an initial registration. Thus, in contrast to the prior art approach where an AMF did not know whether the UE was capable of supporting non-3GPP path switching at the time of registration, in various embodiments such information is made available to the AMF since it is incorporated into the initial registration message in accordance with one feature of the invention. Having such UE capability known to the AMF allow selecting suitable network functions e.g., redirection to another AMF if the AMF to which a UE is initially assigned/connected does not support the same level of path switching capability as the UE. In addition, the AMF to which the UE is assigned is capable of promptly selecting an SMF that has the capability to support the UE's capabilities with proper SMF selection being quickly made during MA PDU session establishment. This avoids the risk of having to select a different SMF at a later time due to the selected SMF failing to support all or some of the path switching capabilities of the UE to which service is to be provided.

In accordance with the invention, a UE and 5GC exchange capabilities to enable an efficient solution for data path switching between two non-3GPP access paths.

Note that capability exchange can also occur during registration with 3GPP access network as defined in clause 4.2.2.2.2 of TS 23.502 and other non-3GPP access types (i.e., trusted non-3GPP access in TS 23.502 clause 4.12a.2.2, wireline non-3GPP access 3GPP TS 23.316 V17.2.0 (2021 December) clause 7.2.1.

The exchange of Non-3GPP path switching capability information between UE and 5GC during registration has the following benefits as to approaches which do not include such an capability information exchange: i) it has the potential to reduce signaling in the network as well as on the device and ii) facilities prompt selection of suitable network functions (e.g., AMF, SMF).

While discussed in terms of 5G terminology it should be appreciated that the methods and apparatus can be used with other communications standards and systems which support the same or similar functionality.

Numerous variations on the above described methods and embodiments will be discussed in the detailed description which follows.

### BRIEF DESCRIPTION OF THE FIGURES

FIG. 1A is first part of a drawing illustrating a known procedure for enabling data traffic switching between two non-33PP access paths.

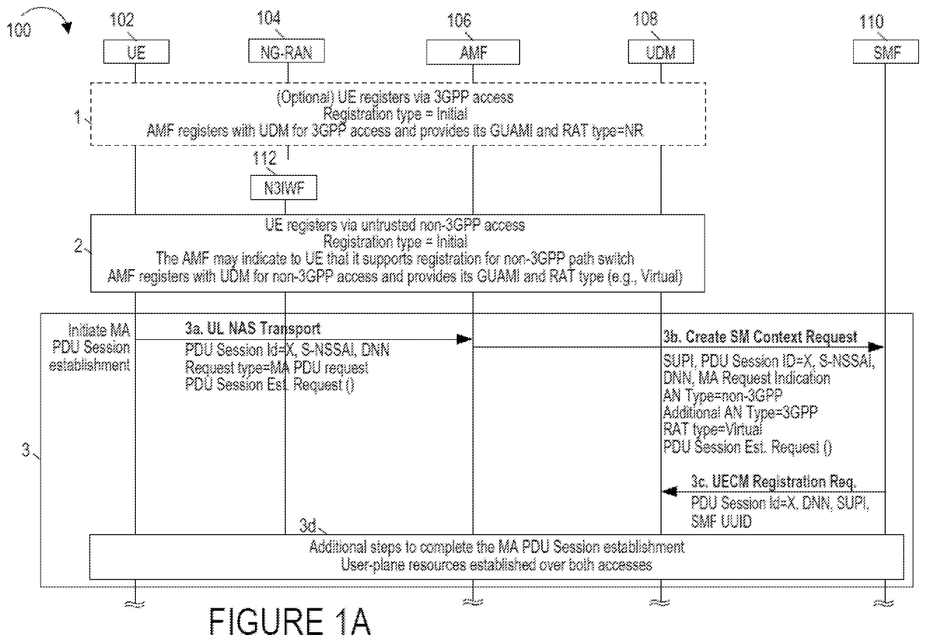

FIG. 1B is a second part of a drawing illustrating a known procedure for enabling data traffic switching between two non-33PP access paths.

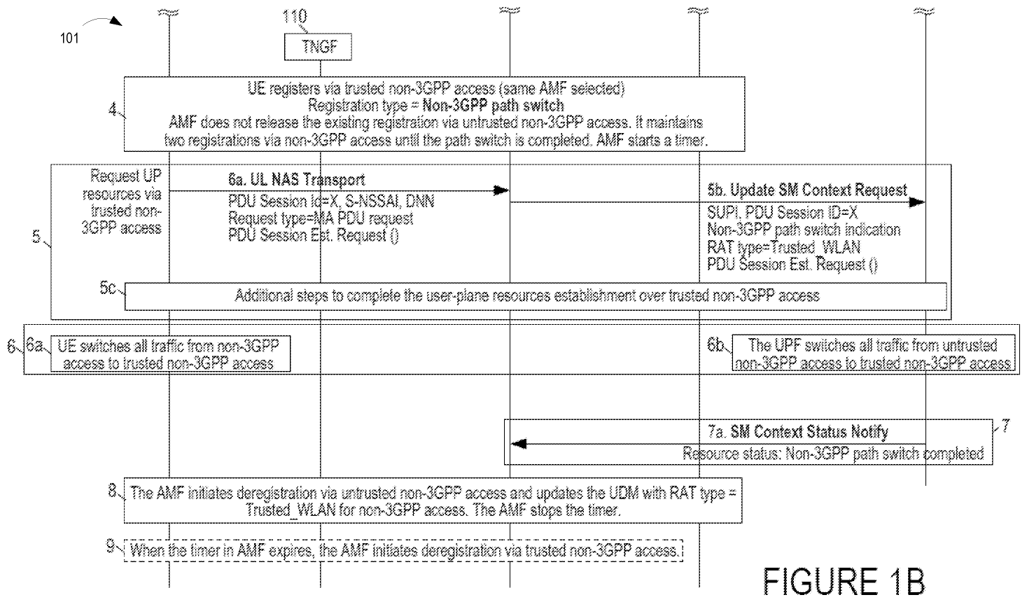

FIG. 1 comprises the combination of FIG. 1A and FIG. 1B.

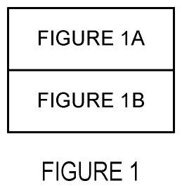

FIG. 2 is a drawing of an exemplary communications system in accordance with an exemplary embodiment.

FIG. 3 is a drawing illustrating exemplary signaling and operations of an exemplary communications method.

FIG. 4 is a drawing of an exemplary user equipment (UE) in accordance with an exemplary embodiment.

FIG. 5 is drawing of an exemplary access network device, e.g., a 3GPP NG-RAN gNB base station, an untrusted N3GPP Access Point, or a Trusted N3GPP Access Point (TNAP), in accordance with an exemplary embodiment.

FIG. 6 is a drawing of an exemplary network interface device, e.g. a non-3GPP Interworking Function (N3IWF) device, a Trusted Non-3GPP Gateway Function (TNGF) device or another gateway device, in accordance with an exemplary embodiment.

FIG. 7 is a drawing of an exemplary access and mobility management function (AMF), e.g., an AMF server, in accordance with an exemplary embodiment.

FIG. 8 is a drawing of an exemplary system, e.g., a server or cloud based processing system including an access and mobility management function (AMF), a session management function (SMF), a unified data management (UDM), a policy control function (PCF) and/or user plane function (UPF) with ATSSS functionality, or a data network (DN) server, which can be part of a PLMN or to implement PLMN functionality in accordance with an exemplary embodiment.

FIG. 9A is a first part of a signaling diagram illustrating signals and operations of a method of registration via untrusted non-3GPP access in accordance with an exemplary embodiment.

FIG. 9B is a second part of a signaling diagram illustrating signals and operations of a method of registration via untrusted non-3GPP access in accordance with an exemplary embodiment.

FIG. 9 comprises the combination of FIG. 9A and FIG. 9B.

FIG. 10 is a drawing of an exemplary assembly of components which may be included in a user equipment (UE) in accordance with an exemplary embodiment.

FIG. 11 is a drawing of an exemplary assembly of components which may be included in a network interface device in accordance with an exemplary embodiment.

FIG. 12 is a drawing of an exemplary assembly of components which may be included in an access and mobility management function (AMF) in accordance with an exemplary embodiment.

FIG. 13 is a flowchart of an exemplary method of operating a first UE device in accordance with an exemplary embodiment.

FIG. 14 is a flowchart of another exemplary method of operating a first UE device in accordance with an exemplary embodiment.

### DETAILED DESCRIPTION

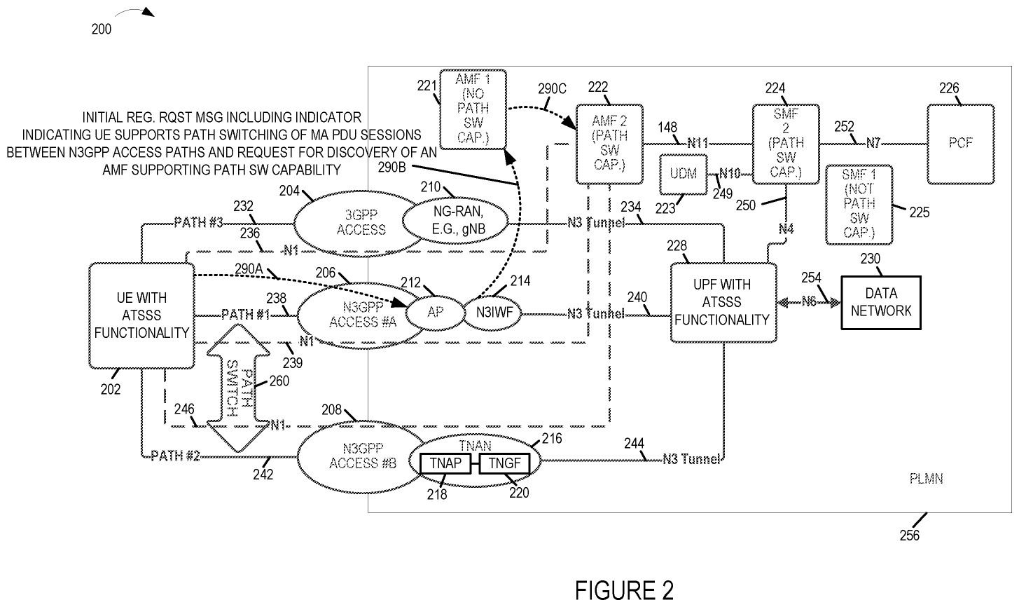

FIG. 2 is a drawing of an exemplary communications system 200 in accordance with an exemplary embodiment. Exemplary communications system 200 includes a UE 202 with Access Traffic Steering, Switching and Splitting (ATSSS) functionality, a 3rd generation partnership project (3GPP) radio access network (RAN) 204, a first non-3GPP (N3GPP) radio access network, which is N3GPP radio access network #A 206, a second N3GPP radio access network, which is N3GPP radio access network #B 208, a first access and mobility management function (AMF), which is AMF 1 221, a second AMF, which is AMF 2 222, a unified data management (UDM) 223, a first session management function (SMF), which is SMF 1 225, a second SMF, which is SMF 2 224, a PCF 226, a user plane function (UPF) 228 with ATSSS functionality, and a data network (DN) 230 coupled together as shown. AMF 1 221 does not include the capability of supporting path switching of MA PDU sessions between N3GPP access paths. AMF 2 222 does include the capability of supporting path switching of MA PDU sessions between N3GPP access paths. SMF 1 225 does not include the capability of supporting path switching of MA PDU sessions between N3GPP access paths. SMF 2 224 does include the capability of supporting path switching of MA PDU sessions between N3GPP access paths.

3GPP radio access network 204 including a NG-RAN 110 including, e.g., a gNB base station. N3GPP radio access network #A 206 includes an access point (AP) 212, e.g., a untrusted WiFi AP, coupled to a Non-3GPP Interworking Function (N3IWF) 214. N3GPP radio access network #B 208 includes a trusted Non-3GPP access network (TNAN) 216 including a Trusted Non-3GPP Access Point (TNAP) 218 and a trusted Non-3GPP Gateway Function (TNGF) 220.

Dashed arrow 290A indicates a message, e.g., an IKE_Auth Request message, including an initial registration request message, including an indicator indicating that the UE 202 supports path switching of MA PDU sessions between N3GPP access paths and requests for discovery of an AMF supporting path switching of MA PDU sessions between N3GPP access paths, being sent from UE 202 to the N3GPP access #A network 206. Dashed Arrow 290B indicates the initial registration request message, including the indicator indicating that the UE 202 supports path switching of MA PDU sessions between N3GPP access paths and requests for discovery of an AMF supporting path switching of MA PDU sessions between N3GPP access paths, being sent from N3IWF 214 to AMF 1 221, which is the AMF selected by the N3IWF 214, e.g. based on access network (AN) parameters and local rules. In this case the AMF 1 221 receives the initial registration request messages and recovers the communicated information indicating that UE 221 request an AMF which supports path switching of MA PDU session between N3GPP access path, and since AMF 1 221 does not satisfy the request, AMF 1 221 searches for another AMF which will satisfy the request. AMF 1 221 discovers AMF 2 222, which supports path switching of MA PDU sessions between N3GPP access paths, and AMF 1 221 sends, e.g., forwards, the received initial registration request, as initial registration request message 290C to AMF 2 222, which receives the initial registration request from UE 202. Since AMF 2 222 can satisfy the request, AMF 2 222 registers with UDM 223 and sends a registration accept message to UE 202 via N3GPP access network 206. The registration accept message includes a globally unique AMF identifier (GUAMI) corresponding to AMF 2 222 and an indicator indicating that AMF 2 222 supports path switching of MA PDU sessions between N3GPP access paths. UE 202 uses the received GUAMI corresponding to AMF 2 222 on further communications, e.g., subsequent registrations request for other access networks.

UE 202 is coupled to 3GPP radio access network 204 via wireless path #3 232. UE 202 is coupled to N3GPP radio access network #A 206 via wireless path #1 238. UE 202 is coupled to N3GPP radio access network #B 208 via wireless path #2 242. N3 tunnel 234 couples 3GPP radio access network 204 to UPF 228. N3 tunnel 240 couples N3GPP radio access network #A 106 to UPF 228. N3 tunnel 244 couples N3GPP radio access network #B 206 to UPF 228.

N1 connection 236 couples UE 202 to AMF 222, via 3GPP access radio network 204. N1 connection 239 couples UE 202 to AMF 222, via N3GPP radio access network #A 206. N1 connection 246 couples UE 202 to AMF 222, via N3GPP radio access network #B 208. N11 connection 248 couples AMF 222 to SMF 224. N7 connection 252 couples SMF 224 to PCF 226. N10 connection 249 couples UDM 223 to SMF 224. N4 connection 250 couples SMF 224 to UPF 228. N6 connection 254 couples UPF 228 to data network 230.

The 3GPP access network 204, AMF 1 221, AMF 2 222, UDM 223, SMF 1 225, SMF 2 224, PCF 226, UPF 228, and data network 230 are part of the same public land mobile network (PLMN) 256.

Large arrow 260 indicates that the access path for traffic data can be, and sometimes is, switched between path #1 238 (corresponding to a first N3GPP access network) and path #2 242 (corresponding to a second N3GPP access network), while maintaining an ongoing multi-access (MA) communications session including path #3 (corresponding to the 3GPP access network 204), in accordance with the exemplary embodiment.

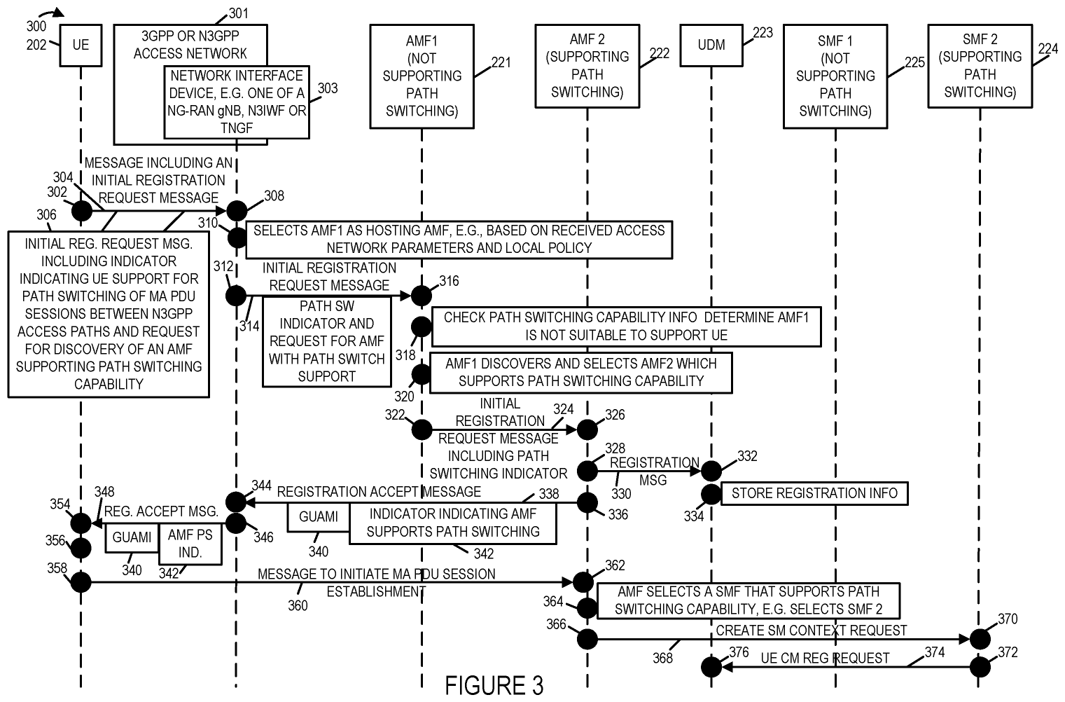

FIG. 3 is drawing 300 illustrating exemplary elements in an exemplary communications system, exemplary signaling, and exemplary operations of an exemplary communications method in accordance with an exemplary embodiment. Drawing 300 include UE 202, a 3GPP or N3GPP access network 301 including an access network device or set of access network devices, a network interface device 303, AMF 1 221, AMF 2 222, UDM 223, SMF 1 225, and SMF 2 224. UE 202, AMF 1 221, AMF 2 222, UDM 223, SMF 1 225, and SMF 2 224 are part of system 200 of FIG. 2. 3GPP or N3GPP access network 301 is, e.g., one of: 3GPP access network 204 of system 200 of FIG. 2, non-trusted N3GPP access network 206 of system 200 of FIG. 2 or trusted N3GPP access network 208 of system 200 of FIG. 2. Network interface device 303 is, e.g., one of: NG-RAN gNB base station 210, N3IWF 214, or TNGP 220, of system 200 of FIG. 2. NG-RAN gNB base station 210 is part of 3GPP access network 204. N3IWF 214 is coupled to AP 212 of N3GPP access network 206. TNGF 216 is part of N3GPP access network 208. In this example UE 202 is a UE with ATSSS functionality which supports path switching of MA PDU sessions between N3GPP access paths. AMF 2 222 and SMF 2 224 support path switching of MA PDU sessions between N3GPP access paths. AMF 1 221 and SMF 1 225 do not support path switching of MA PDU sessions between N3GPP access paths.

In step 302 UE 202 generates and sends message 304 including an initial registration request message to a network interface device 303. In one exemplary embodiment, message 304 is an IKE Authorization Request Message including AN-Parameters and the initial registration request message; and the network interface device 303 is N3IWF 214. The initial registration request message includes path switching capability information indicating whether the UE 202 support path switching of MA PDU session between N3GPP access paths. The initial registration request message, in this example, includes an indicator indicating UE 202 supports path switching of MA PDU sessions between N3GPP access paths and requests discovery of an AMF which supports path switching of MA PDU sessions between N3GPP access paths. In various embodiments, the initial registration message includes a registration type=initial.

In step 308 the network interface device 303 receives message 304. In step 310 the network interface device 303 selects AMF 1 221 as the hosting AMF, e.g., based on received access network parameters and local policy. In various embodiments, the network interface device 303 does not consider the path switching capability of the UE 202 when making the initial AMF selection of step 310, e.g., because the network interface device 303 does not have access to the path switching information included in the initial registration request message, but the path switching information in the initial registration request message can be accessed by an AMF.

In step 312 the network interface device 303 sends message 314 to AMF 1 221. Message 314 is the initial registration message including the indicator indicating UE support for path switching of MA PDU sessions between N3GPP access paths and the request for discovery of an AMF supporting the path switching capability.

In various embodiments, the said initial registration request message is included in message 304 as part of a payload of said message 304, the content of said initial registration message not being fully accessible to the network interface device 303 but being accessible to one or more AMFs to which the initial registration message is communicated.

In step 316 AMF 1 receives message 314 and recovers the communicated information. In step 318 AMF 1 221 determines if the hosting AMF (which is AMF 1 221) can support a level of path switching capability that UE 202 supports as indicated by the path switching capability information included in the initial registration message. In step 318 AMF 1 221 determines that AMF 1 221 is not suitable to support UE 202, since UE 202, the path switching information communicated in the initial registration message indicates that UE 202 supports path switching of MA PDU sessions for N3GPP access paths; UE 202 is requesting an AMF that supports path switching, and AMF 1 221 does not have that capability. In step 320 AMF 1 221 performs discovery searching for other AMF(s) which support path switching of MA PDU sessions between N3GPP access paths and would be suitable for UE 202, identifies one or more candidates AMFs which support path switching of MA PDU sessions for N3GPP access paths, and selects AMF 2 222 which is one of the candidates which supports the path switching. In step 322 AMF 1 221 sends, e.g., forwards, the received initial registration request message including the path switching indicator, as message 324 to AMF 2 222.

In step 328 AMF 2 222 receives the initial registration request message 324, recovers the communicated information, determines that AMF 2 222 will satisfy UE 202 since AMF 2 222 supports path switching. In step 328 AMF 2 222 generates and sends a registration message 330 to UDM 223. In step 332 UDM 223 receives registration message 332, and performs registration operations. In step 334, the UDM 223 stores registration information 334 corresponding to UE 202 and AMF 222. In step 336 AMF 2 222 generates and sends a registration accept message 338 to network interface device 303. The registration accept message 338 includes a globally unique AMF identifier (GUAMI) corresponding to AMF 2 222 and an indicator indicating that AMF 2 222 supports path switching of MA PDU sessions between N3GPP access paths.

In step 344 the network interface device 303 receives registration accept message 338. In step 346 network interface device 303 generates and sends registration accept message 348 to UE 202. Message 348 includes GUAMI 340, and the indicator 342 indicating that AMF 2 supports path switching. In step 354 UE 202 receives the registration accept message 348 and recovers the communicated information. In step 356, the UE 202 stores the recovered information including the GUAMI indicating that AMF 2 202 is the AMF, supporting UE 202 and AMF 2 202 supports path switching of MA PDU sessions between N3GPP access paths.

In step 358 UE 202 generates and sends a message 360 to initiate MA PDU session establishment to AMF 2 222. In step 362 AMF 2 222 receives message 360. In step 364 AMF 2 22 selects a SMF that supports the path switching capability, e.g., selects SMF 2 224, from among a plurality of alternative SMFs some of which do not support path switching (e.g., SMF 1 225) and some of which do support path switching (e.g., SMF 2 224). In step 366 AMF 2 222 generates and sends create SM context request message 368 to SMF 2 224 to create context for UE 202 at SMF 2 224. In step 370 SMF 224 receives create SM context request 368, and in response in step 372 SMF 2 224 generates and sends UE CM registration request 374 to UDM 223.

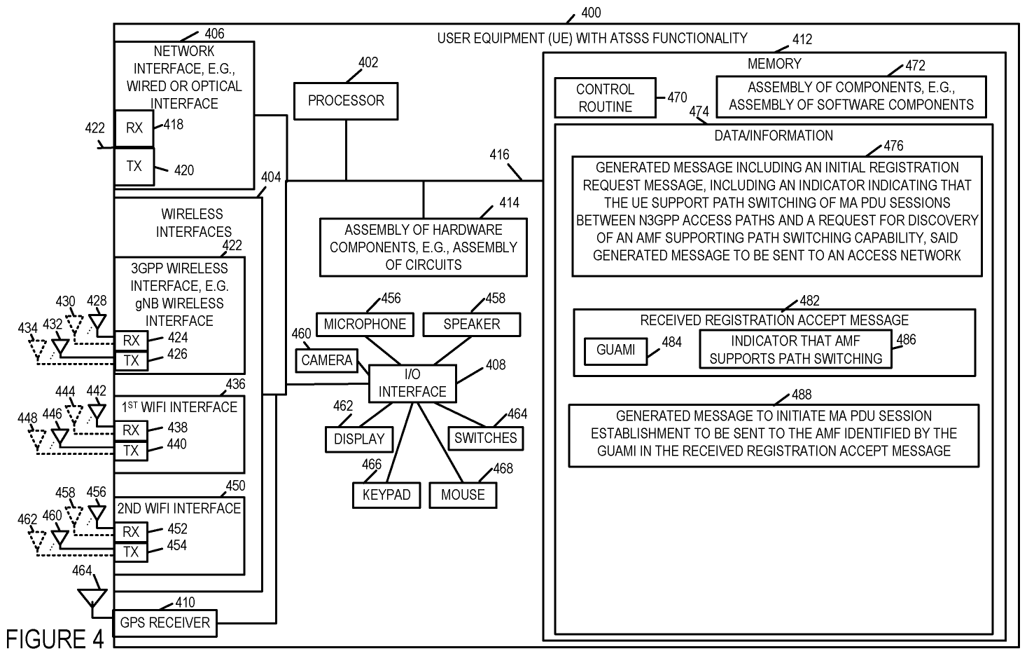

FIG. 4 is a drawing of an exemplary user equipment (UE) 400 with ATSSS functionality in accordance with an exemplary embodiment. UE 400 is, e.g., UE 202 of system 200 of FIG. 2. UE 400 includes a processor 402, e.g., a CPU, wireless interfaces 404, a network interface 406, an I/O interface 408, a GPS receiver 410, memory 412, an assembly of hardware components 414, e.g., an assembly of circuits, coupled together via a bus 416. UE 400 further includes a plurality of I/O devices (microphone 456, speaker 458, camera 460, display 462, e.g., a touch screen display, switches 464, keypad 466, mouse 468) coupled to I/O interface 408, which couples the I/O devices to bus 416 and other components within UE 400.

Wireless interfaces 404 includes a 3GPP wireless interface 422, e.g., a gNB wireless interface, a 1st WiFi interface 436 and a 2nd WiFi interface 450. 3GPP wireless interface 422 includes wireless receiver 424 coupled to one or more receive antennas (428, . . . , 430), via which the UE 400 receives cellular signals, e.g., from a gNB base station. 3GPP wireless interface 422 further includes wireless transmitter 426 coupled to one or more transmitter antennas (432, . . . , 434), via which the UE 400 transmits cellular signals, e.g., to a gNB base station. 1st WiFi interface 436 includes wireless receiver 438 coupled to one or more receive antennas (442, . . . , 444), via which the UE 400 receives WiFi signals, e.g., from a first N3GPP access point. 1st WiFi wireless interface 436 further includes wireless transmitter 440 coupled to one or more transmitter antennas (446, . . . , 448), via which the UE 400 transmits WiFi signals, e.g., to a first N3GPP AP. 2nd WiFi interface 450 includes wireless receiver 452 coupled to one or more receive antennas (456, . . . , 458), via which the UE 400 receives WiFi signals, e.g., from a second N3GPP access point. 2nd WiFi wireless interface 450 further includes wireless transmitter 454 coupled to one or more transmitter antennas (460, . . . , 462), via which the UE 400 transmits WiFi signals, e.g., to a second N3GPP AP. In some embodiments, the same antenna or antennas are used for both transmit and receive, e.g., in a time duplex division embodiment. In some embodiments, the same WiFi interface is used for communicating with multiple WiFi APs. In some embodiments, different WiFi interfaces correspond to different frequency bands.

Network interface 406, e.g., a wired or optical interface, includes a receiver 418 and a transmitter 420 coupled to connector 422 which may, and sometimes does, couple the UE 400 to other network nodes and/or the Internet via a wired or optical connection, e.g., when the UE 400 is at a location where a wired or optical connection is available.

Memory 412 includes a control routine 470, e.g., for controlling the UE 400 to implement basis functions, e.g., memory access operations, I/O device control, receiver control, etc., and an assembly of components 472, e.g., an assembly of software components, and data/information 474. Assembly of components includes, e.g., routines, subroutines, software modules, and/or applications, which when executed by the processor 402 control the UE 400 to implement steps of an exemplary method, e.g., steps of the exemplary communications method of FIG. 3, which are performed by the UE 202. Data/information 474 includes a generated message 476 including an initial registration request message, including an indicator indicating that the UE supports path switching of MA PDU sessions between N3GPP access paths and a request for discovery of an AMF supporting path switching capability of MA PDU sessions between N3GPP access paths, a received registration accept message 482 including a GUAMI 484 of a AMF, and an indicator 486 indicating the AMF supports path switching capability of MA PDU sessions between N3GPP access paths, and a generated message 488 to initiate a MA PDU session establishment, said message to be sent to the AMF identified by GUAMI in the received registration accept message.

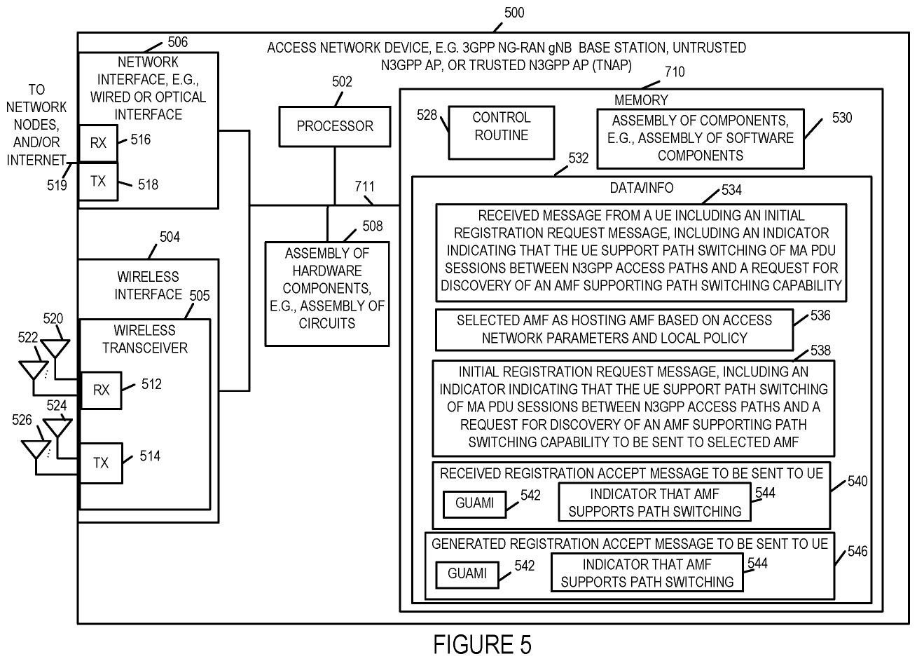

FIG. 5 is drawing of an exemplary access network (AN) device 500, e.g., a 3GPP NG-RAN gNB base station, an untrusted N3GPP access point, e.g., AP 212, or a trusted N3GPP AP (TNAP) 118, in accordance with an exemplary embodiment. In some embodiments, AN device 500 is network interface device 303 of FIG. 3. Exemplary access network device 500 includes a processor 502, e.g., a CPU, a wireless interface 504, e.g., a cellular or a WiFi interface, a network interface 506, e.g., a wired or optical interface, an assembly of hardware components 508, e.g., an assembly of circuits, and memory 510 coupled together via a bus 511 over which the various elements interchange data and information.

Wireless interface 504 includes a wireless receiver 512 coupled to a plurality of receive antennas (520, . . . , 522), via which the access network device 500 receives wireless signals from UEs, and a wireless transmitter 514 coupled to one or more transmit antennas (524, . . . , 526), via which the access network device 500 transmits wireless signals to UEs. In some embodiments, the receiver 512 and transmitter 514 are part of a transceiver 505, e.g., a cellular or WiFi transceiver. In some embodiment one or more antennas are used for both receive and transmit, e.g., in a TDD embodiment.

Network interface 506 includes a receiver 516 and a transmitter 518 coupled to connector 519, which couples the access network device 500 to other network nodes, e.g., other APs, base stations, various servers or devices including an AMF, SMF, UDM, PCF and/or UPF with ATSSS functionality, a data network (DN) server, various core network devices, routers, etc. and/or the Internet. Memory 510 includes a control routine 528 and an assembly of components 530, e.g., an assembly of software components, and data/information 532.

Data/information 532 includes a received message 534 from a UE including an initial registration request message including an indicator indicating that the UE supports path switching of MA PDU sessions between N3GPP access paths and a request for discovery of an AMF supporting the path switching capability, information 536 indicating an AMF selected as hosting AMF based on access network parameters and local policy, an initial registration request message 538 including an indicator indicating the UE supports path switching of MA PDU sessions between N3GPP access paths and a request for discovery of an AMF supporting the path switching capability, to be sent to the selected AMF, a received registration accept message 540, from a AMF which satisfied the UE requirements, to be sent to the UE. Registration accept message 540 includes a globally unique AMF identifier (GUAMI) 542 and an indicator 544 indicating that the AMF identified by the identifier supports path switching. Data/information 532 further include a generated registration accept message 546 to be sent to the UE which includes GUAMI 542 and indicator information 544.

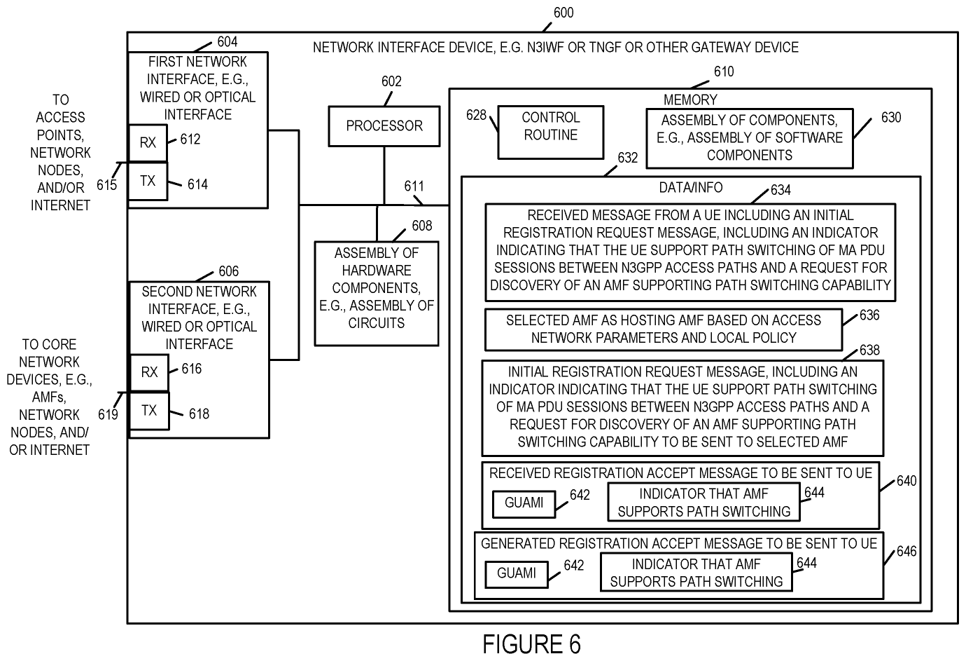

FIG. 6 is a drawing of an exemplary network interface device 600, e.g., a non-3GPP Interworking Function (N3IWF) device, a Trusted Non-3GPP Gateway Function (TNGF) device or another gateway device, in accordance with an exemplary embodiment. Network interface device 600 is, e.g., N3IWF device 214 of system 200 of FIG. 2, TNGF device 120 of system 200 of FIG. 2, or network interface device 303 of FIG. 3.

Exemplary network interface device 600 includes a processor 602, e.g., a CPU, a first network interface 604, e.g., a wired or optical interface, a second network interface 606, e.g., a wired or optical interface, an assembly of hardware components 608, e.g., an assembly of circuits, and memory 610 coupled together via a bus 611 over which the various elements interchange data and information.

First network interface 604 includes a receiver 612 and a transmitter 614 coupled to connector 615, which couples the network interface device 600 to APs, network nodes and/or the Internet.

Second network interface 606 includes a receiver 616 and a transmitter 618 coupled to connector 619, which couples the network interface device 600 to core network devices, e.g., AMF, SMF, UDM, PCF and/or UPF with ATSSS functionality, a data network (DN) server, various core network devices, routers, etc. and/or the Internet. Memory 610 includes a control routine 628 and an assembly of components 630, e.g., an assembly of software components, and data/information 632.

Data/information 632 includes a received message 634 from a UE including an initial registration request message including an indicator indicating that the UE supports path switching of MA PDU sessions between N3GPP access paths and a request for discovery of an AMF supporting the path switching capability, information 636 indicating an AMF selected as hosting AMF, e.g. based on access network parameters and local policy, an initial registration request message 638 including an indicator indicating the UE supports path switching of MA PDU sessions between N3GPP access paths and a request for discovery of an AMF supporting the path switching capability, to be sent to the selected AMF, a received registration accept message 640, from a AMF which satisfied the UE requirements, to be sent to the UE. Registration accept message 640 includes a globally unique AMF identifier (GUAMI) 642 and an indicator 644 indicating that the AMF identified by the identifier supports path switching. Data/information 632 further include a generated registration accept message 646 to be sent to the UE which includes GUAMI 642 and path switching indicator information 644.

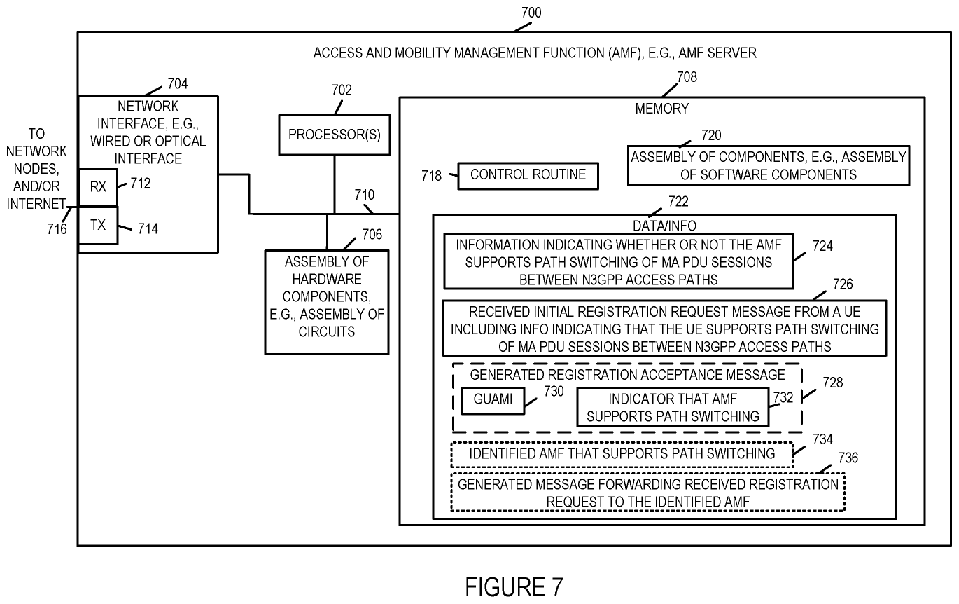

FIG. 7 is a drawing of an exemplary access and mobility management function (AMF) 700, e.g., an AMF server, in accordance with an exemplary embodiment. AMF 700 is, e.g., AMF 1 221 or AMF 2 222 of system 200 of FIG. 2 or FIG. 3.

AMF 700 includes a processor 702, e.g., a CPU, a network interface 704, e.g., a wired or optical interface, an assembly of hardware components 708, e.g., an assembly of circuits, and memory 710 coupled together via a bus 711 over which the various elements interchange data and information.

Network interface 704 includes a receiver 712 and a transmitter 714 coupled to connector 716, which couples the AMF 700 to base stations such as 3GPP gNBs, N3IWF devices, TNGF devices, network nodes, core network devices, e.g., other AMFs, SMFs, UDM, PCF and/or UPF with ATSSS functionality, a data network (DN) server, various other core network devices, routers, etc. and/or the Internet.

Memory 708 includes a control routine 718, an assembly of components 720, e.g., an assembly of software components, and data/information 722. Data/information 722 includes information 724 indicating whether or not the AMF 700 supports path switching of MA PDU sessions between N3GPP access paths, and a received initial registration request message from a UE including information indicating that the UE supports path switching of MA PDU session between N3GPP access paths. Data information 722, in some embodiments, e.g., an embodiment in which AMF 700 supports path switching, includes a generated registration acceptance message 728 including a GUAMI 730, which identifies AMF 700, and an indicator 732 indicating that the AMF 700 supports path switching of MA PDU sessions between N3GPP access paths. Data information 722, in some embodiments, e.g., an embodiment in which AMF 700 does not support path switching, includes information 734 identifying an identified selected AMF that supports path switching, and a generated message 736 forwarding the received initial registration request message to the identified AMF.

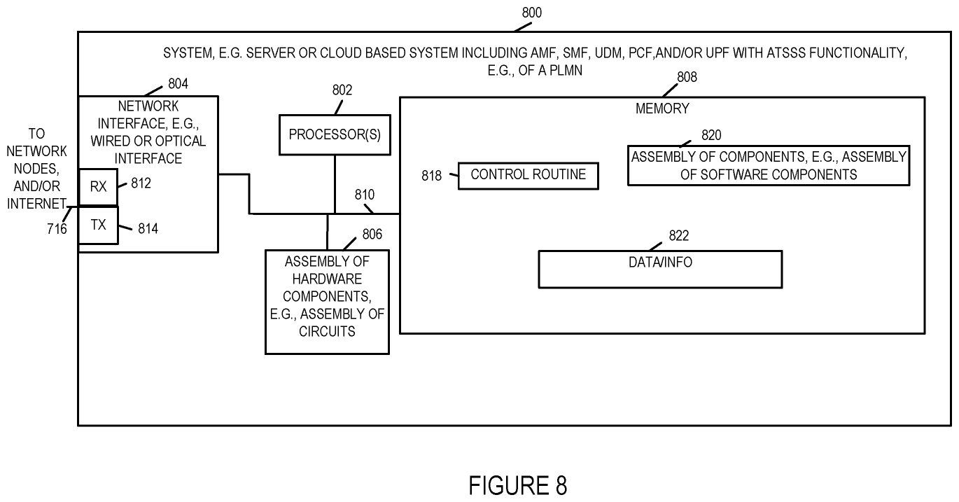

FIG. 8 is a drawing of an exemplary system 800, e.g., a server or cloud network including an interface and one or more processors which provide AMF, SMF, UDM, PCF and/or UPF with ATSSS functionality, or a data network (DN) server, in accordance with an exemplary embodiment. Exemplary system 800 includes a processor 802, e.g., a CPU, a network interface 804, e.g., a wired or optical interface, an assembly of hardware components 806, e.g., an assembly of circuits, and memory 808 coupled together via a bus 810 over which the various elements interchange data and information.

Network interface 804 includes a receiver 812 and a transmitter 814 coupled to connector 816, which couples the server 800 to other network nodes, e.g., other servers, core network devices, routers, etc. and/or the Internet. Memory 808 includes a control routine 818 and an assembly of components 820, e.g., an assembly of software components, and data/information 822.

Various aspects and/or features of some embodiments of the present invention are described below.

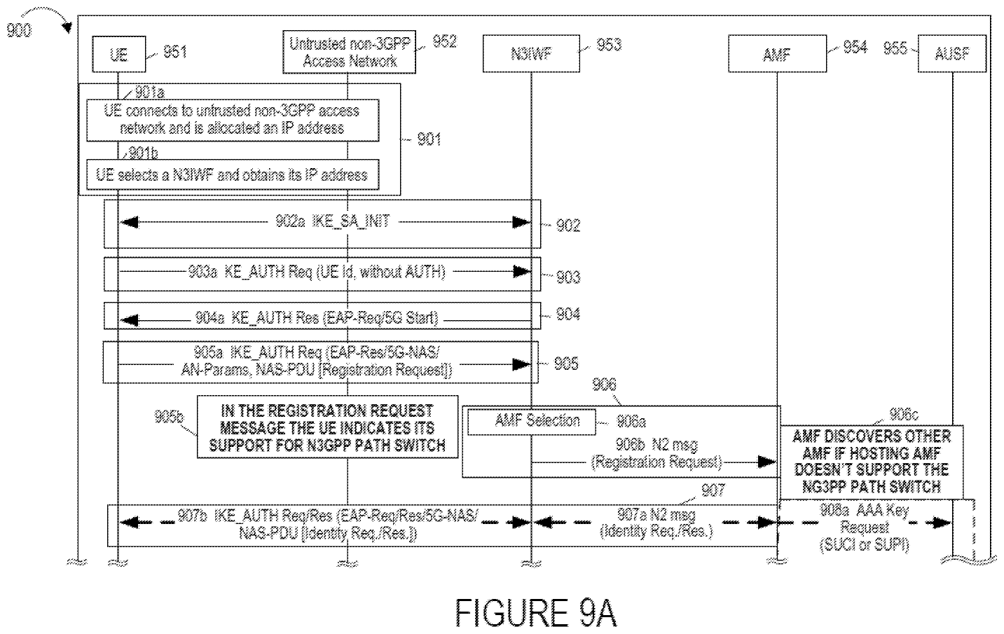

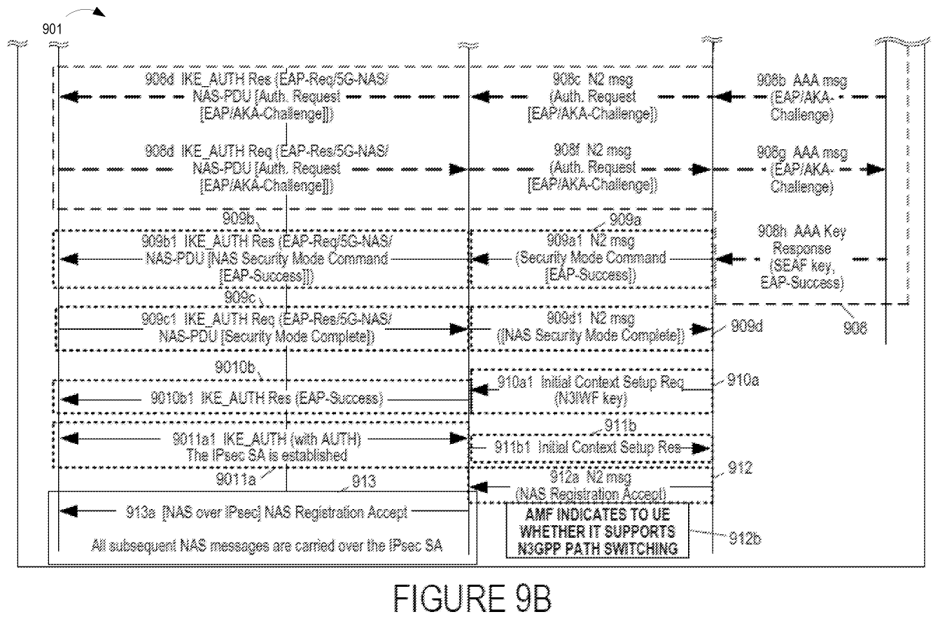

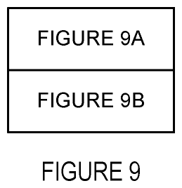

A registration procedure for untrusted non-3GPP access will now be discussed with reference to FIG. 9. FIG. 9 comprises the combination of FIG. 9A and FIG. 9B. The signaling flow 900 shown in FIG. 9A in combination with the signaling flow 901 shown in FIG. 9B shows a novel registration process via untrusted non-3GPP access in which UE and AMF capability information is exchanged at an early stage in the registration process. It shows, among other things, steps executed between the UE and N3IWF.

Drawing 900 of FIG. 9 shows exemplary Registration via untrusted non-3GPP access. Drawing 900 shows exemplary UE 951, exemplary untrusted non-3GPP access network 952, exemplary non-3GPP interworking function (N3IWF) 952, exemplary access and mobility management function (AMF) 954), and exemplary authentication server function (AUSF) 955. Drawing 900 illustrates exemplary steps 901, 902, 903, 904, 905, 906, 907, 908, 909, 910, 911, 912 and 913, and each of the steps corresponds to one or more operations.

Step 901. The UE 951 connects to an untrusted non-3GPP Access Network 952 with any appropriate authentication procedure, and it is assigned an IP address. For example, a non-3GPP authentication method can be used, e.g., no authentication (in the case of a free WLAN), EAP with pre-shared key, username/password, etc. When the UE 951 decides to attach to 5GC network, the UE 951 selects an N3IWF 953 in a 5G PLMN, as described in clause 6.3.6 of 3GPP TS 23.501 V17.4.0 (2022 March).

Step 902. The UE 951 proceeds with the establishment of an IPsec Security Association (SA) with the selected N3IWF 953 by initiating an IKE initial exchange 902a according to IETF RFC 7296, ISSN: 2070-1721 (October 2014). After step 902, all subsequent IKE messages are encrypted and integrity protected by using the IKE SA established in this step.

Step 903. The UE 951 shall initiate an IKE_AUTH exchange by sending an IKE_AUTH request message 903a. The AUTH payload is not included in the IKE_AUTH request message 903a, which indicates that the IKE_AUTH exchange shall use EAP signalling (in this case EAP-5G signalling). If the UE 951 supports MOBIKE, it shall include a Notify payload in the IKE_AUTH request 903a, as specified in IETF RFC 4555 (June 2006), indicating that MOBIKE is supported. In addition, as specified in 3GPP TS 33.501 V17.5.0 (2022 March), if the UE 951 is provisioned with the N3IWF root certificate, it shall include the CERTREQ payload within the IKE_AUTH request message 903a to request the N3IWF's certificate.

Step 904. The N3IWF 953 responds with an IKE_AUTH response message 904a, which includes an EAP-Request/5G-Start packet. The EAP-Request/5G-Start packet informs the UE 951 to initiate an EAP-5G session, i.e., to start sending NAS messages encapsulated within EAP-5G packets. If the N3IWF 953 has received a CERTREQ payload from the UE 951, the N3IWF 953 shall include the CERT payload in the IKE_AUTH response message 904a containing the N3IWF's certificate. How the UE 951 uses the N3IWF's certificate is specified in TS 33.501.

Step 905. The UE 951 shall send an IKE_AUTH request 905a, which includes an EAP-Response/5G-NAS packet that contains the Access Network parameters (AN parameters) and a Registration Request message. The AN parameters contain information that is used by the N3IWF 953 for selecting an AMF in the 5G core network. This information includes e.g., the GUAMI, the Selected PLMN ID (or PLMN ID and NID, see clause 5.30 of TS 23.501), the Requested NSSAI and the Establishment cause. The Establishment cause provides the reason for requesting a signaling connection with 5GC. Whether and how the UE 951 includes the Requested NSSAI as part of the AN parameters is dependent on the value of the Access Stratum Connection Establishment NSSAI Inclusion Mode parameter, as specified in clause 5.15.9 of TS 23.501.

NOTE 1: The N3IWF 953 does not send an EAP-Identity request because the UE 951 includes its identity in the first IKE_AUTH. This is in line with RFC 7296 clause 3.16.

Step 906. The N3IWF 953 shall select (906a) an AMF based on the received AN parameters and local policy, as specified in clause 6.3.5 of TS 23.501. In the Registration Request message in step 905 above, the UE 951 indicates it support for “Non-3GPP path switch”, as indicated by block 905b.

“Non-3GPP path switch” indication indicates that this UE 951 is capable of Switching traffic of an MA PDU Session between two non-3GPP access paths and requesting the discovery of an AMF that supports this capability.

This registration request indicates that the registration over non-3GPP access is requested for switching the data traffic of an MA PDU Session from one non-3GPP access path to another non-3GPP access path.

The N3IWF 953 shall then forward the Registration Request received from the UE 951 to the selected AMF, e.g., AMF 954, within an N2 message 906b.

If “Non-3GPP path switch” capability isn't supported by Hosting AMF, it may discover other AMFs (as indicated by block 906c) using NF discover & selection procedures.

This message contains N2 parameters that include the Selected PLMN ID and the Establishment cause.

Step 907. The selected AMF 954 may decide to request the SUCI by sending a NAS Identity Request message to UE 951 (see N2 message 907a which conveys the Identity Request message from the AMF 954 to the N3IWF 953 and IKE_Auth Request message 907b which conveys the Identity Request message from the N3IWF 953 to the UE 951). This NAS message and all subsequent NAS messages are sent to UE 951 encapsulated within EAP/5G-NAS packets.

Step 908. The AMF 954 may decide to authenticate the UE 951 by invoking an AUSF. In this case, the AMF 954 shall select an AUSF 955 as specified in clause 6.3.4 of TS 23.501 based on SUPI or SUCI sent to the AUSF 955 from the AMF 954 in AAA Key request message 908a.

The AUSF 955 executes the authentication of the UE 951 as specified in TS 33.501 [15]. The AUSF 955 selects a UDM as described in clause 6.3.8 of TS 23.501 [2] and gets the authentication data from UDM. The authentication packets are encapsulated within NAS authentication messages and the NAS authentication messages are encapsulated within EAP/5G-NAS packets. Messages 908b, 908c, 908d, 908e, 908f and 908h are part of the authentication process. After the successful authentication:

The AUSF 955 shall send the anchor key (SEAF key), in AAA key response message 908h, to AMF 954 which is used by AMF 954 to derive NAS security keys and a security key for N3IWF 953 (N3IWF key). The UE 951 also derives the anchor key (SEAF key) and from that key it derives the NAS security keys and the security key for N3IWF (N3IWF key). The N3IWF key is used by the UE 951 and N3IWF for establishing the IPsec Security Association (in step 911).

The AUSF 955 shall also include the SUPI in AAA Key Response message 908h, if in the AMF 954 provided, in AAA Key Request message 908a, to AUSF 955 a SUCI.

NOTE 2: EAP-AKA′ or 5G-AKA are allowed for the authentication of UE via non-3GPP access, as specified in TS 33.501. FIG. 4.12.2.2-1 only shows authentication flow using EAP-AKA′. Authentication methods other than EAP-AKA′ or 5G-AKA are also allowed for UE accessing SNPN services via a PLMN, as specified in TS 33.501, Annex I.

Step 909a. The AMF 954 shall send a NAS Security Mode Command to UE 951 in order to activate NAS security (See N2 message 909a1 which conveys the NAS Security Mode Command from AMF 954 to N3IWF 953). If an EAP-AKA′ authentication was successfully executed in step 908, the AMF 954 shall encapsulate the EAP-Success received from AUSF 955 within the NAS Security Mode Command message.

Step 909b. The N3IWF 953 shall forward the NAS Security Mode Command message to UE 951 within an EAP/5G-NAS packet of IKE_AUTH response message 909b1.

Step 909c. The UE 951 completes the EAP-AKA′ authentication (if initiated in step 908), creates a NAS security context and an N3IWF key and sends the NAS Security Mode Complete message within an EAP/5G-NAS packet of IKE_AUTH request message 909c1 to N3IWF 953.

Step 909d. The N3IWF 953 relays the NAS Security Mode Complete message to the AMF 954 via N2 message 909d1.

Step 910a. Upon receiving NAS Security Mode Complete, the AMF 954 shall send an NGAP Initial Context Setup Request message 910a1 that includes the N3IWF key to the N3IWF 953.

Step 910b. This triggers the N3IWF 953 to send an EAP-Success, in IKE_AUTH response message 910b1 to UE 951, which completes the EAP-5G session. No further EAP-5G packets are exchanged.

Step 911. The IPsec SA is established between the UE 951 and N3IWF 953 by using the common N3IWF key that was created in the UE 951 in step 909c and received by the N3IWF 953 in step 910a. This IPsec SA is referred to as the “signaling IPsec SA”. After the establishment of the signaling IPsec SA, the N3IWF 952 notifies the AMF 953 that the UE context (including AN security) was created by sending a NGAP Initial Context Setup Response. The signaling IPsec SA shall be configured to operate in tunnel mode and the N3IWF 953 shall assign to UE 951 an “inner” IP address. If the N3IWF 953 has received an indication that the UE 951 supports MOBIKE (see step 903), then the N3IWF 953 shall include a Notify payload in the IKE_AUTH response message 911a1 sent in step 911a, indicating that MOBIKE shall be supported, as specified in RFC 4555.

Subsequent NAS messages exchanged between the UE 951 and N3IWF 953 shall be sent via the signaling IPsec SA and shall be carried over TCP/IP. The UE 951 shall send NAS messages within TCP/IP packets with source address the “inner” IP address of the UE 951 and destination address the NAS_IP_ADDRESS that is received in step 911a. The N3IWF 953 shall send NAS messages within TCP/IP packets with source address the NAS_IP_ADDRESS and destination address the “inner” IP address of the UE. The TCP connection used for reliable NAS transport between the UE 951 and N3IWF 953 shall be initiated by the UE 951 right after the signaling IPsec SA is established in step 911a. The UE 951 shall send the TCP connection request to the NAS_IP_ADDRESS and to the TCP port number specified in 3GPP TS 24.502 V17.5.0 (2022 March).

Step 912. The AMF 954 sends the NAS Registration Accept message 912a to the N3IWF 953. The N2 Message 912a includes the Allowed NSSAI for the access type for the UE 951.

The AMF 954 indicates to the UE 951 whether it supports non-3GPP path switching, as indicated by block 912b.

Step 913. The N3IWF 953 forwards the NAS Registration Accept message, via message 913a, to UE 951 via the established signaling IPsec SA. If the NAS Registration Accept message is received by the N3IWF 953 before the IPsec SA is established, the N3IWF 953 shall store it and forward it to the UE 951 only after the establishment of the signaling IPsec SA.

The AMF 954 provides the Access Type set to “Non-3GPP access” to the UDM when it registers with the UDM.

NOTE 3: The Access Type is set to “Non-3GPP access” even when the UE accesses SNPN services via PLMN over 3GPP access.

Benefits of the described process are provided with Non-3GPP path switching capability exchange between UE and 5GC during registration reducing signaling in the network as well as on the device as compared to systems which do not include such capability exchange.

Furthermore, selection of suitable network functions (e.g., AMF, SMF) is facilitated by the exchange of capability information.

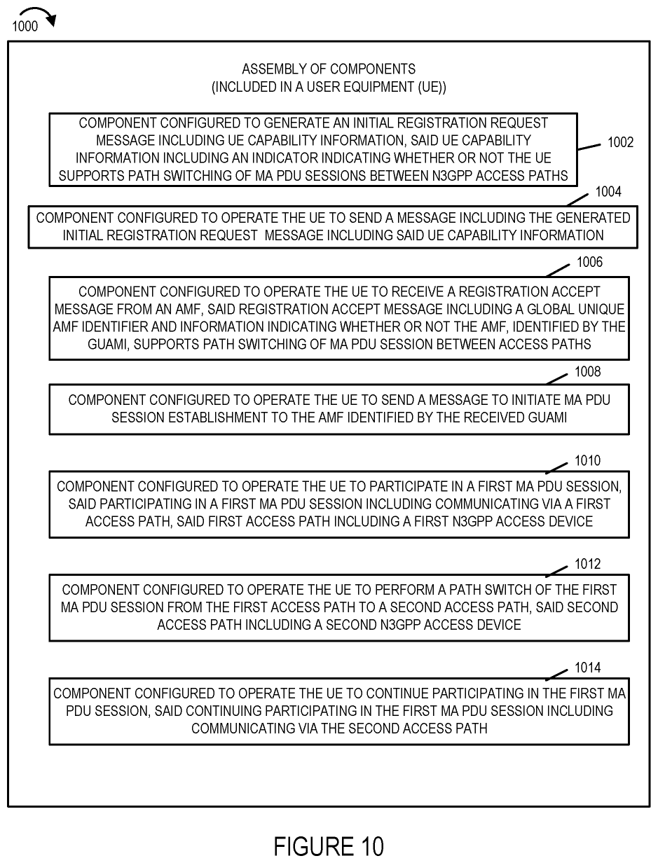

FIG. 10 is a drawing of an exemplary assembly of components 1000 which may be included in a user equipment (UE) in accordance with an exemplary embodiment. Assembly of components 1000 is, e.g., included in a UE 202 of system 200 of FIG. 2, UE 202 of signaling diagram 300 of FIG. 3 and/or UE 400 of FIG. 4, in accordance with an exemplary embodiment.

The components in the assembly of components 1000 can, and in some embodiments are, implemented fully in hardware within a processor, e.g., processor 402, e.g., as individual circuits. The components in the assembly of components 1000 can, and in some embodiments are, implemented fully in hardware within the assembly of hardware components 414, e.g., as individual circuits corresponding to the different components. In other embodiments some of the components are implemented, e.g., as circuits, within processor 402 with other components being implemented, e.g., as circuits within assembly of components 414, external to and coupled to the processor 402. As should be appreciated the level of integration of components on the processor and/or with some components being external to the processor may be one of design choice. Alternatively, rather than being implemented as circuits, all or some of the components may be implemented in software and stored in the memory 412 of the UE 400, with the components controlling operation of UE 400 to implement the functions corresponding to the components when the components are executed by a processor e.g., processor 402. In some such embodiments, the assembly of components 1000 is included in the memory 412 as part of an assembly of software components 472. In still other embodiments, various components in assembly of components 1000 are implemented as a combination of hardware and software, e.g., with another circuit external to the processor providing input to the processor 402 which then under software control operates to perform a portion of a component's function.

When implemented in software the components include code, which when executed by a processor, e.g., processor 402, configure the processor to implement the function corresponding to the component. In embodiments where the assembly of components 1000 is stored in the memory 412, the memory 412 is a computer program product comprising a computer readable medium comprising code, e.g., individual code for each component, for causing at least one computer, e.g., processor 402, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 10 control and/or configure the UE 400 or elements therein such as the processor 402, to perform the functions of corresponding steps illustrated and/or described in the method of one or more of the flowcharts, signaling diagrams and/or described with respect to any of the Figures. Thus, the assembly of components 1000 includes various components that perform functions of corresponding one or more described and/or illustrated steps of an exemplary method, e.g., steps of the method of signaling diagram 300 of FIG. 3.

Assembly of components 1000 includes a component 1002 configured to generate an initial registration request message including UE capability information, said UE capability information including an indicator indicating whether or not the UE supports path switching of MA PDU sessions between N3GPP access paths, and a component 1004 configured to operate the UE to send a message including the generated initial registration request message including said UE capability information, e.g. to a network interface device.

Assembly of components 1000 further includes a component 1006 configured to operate the UE to receive a registration accept message from an AMF, said registration accept message including a globally unique AMF identifier (GUAMI) and information indicating whether or not the AMF, identified by the GUAMI, supports path switching of MA PDU sessions between access paths, and a component 1008 configured to operate the UE to send a message to initiate MA PDU session establishment to the AMF identified by the received GUAMI.

Assembly of components 1000 further includes a component 1010 configured to operate the UE to participate in a first MA PDU session, said participating in the first MA PDU session including communications via a first access path, said first access path including a first N3GPP access device, a component 1012 configured to operate the UE to perform a path switch of the first MA PDU session from the first access path to a second access path, said second access path including a second N3GPP access device, said second access path being different from said first access path and said second access device being different from said first access device, and a component 1014 configured to operate the UE to continue participating in the first MA PDU session, said continuing participating in the first MA PDU session including communications via the first access path.

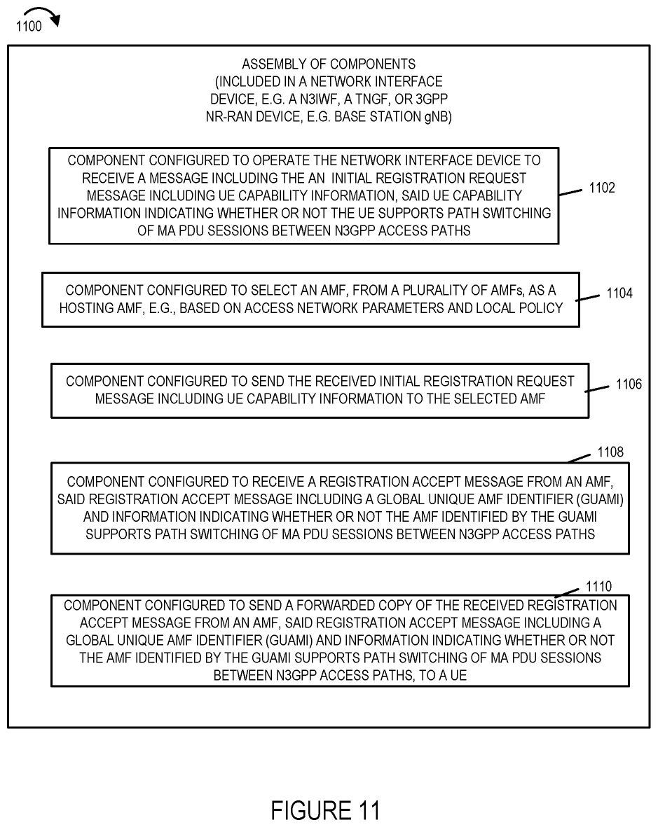

FIG. 11 is a drawing of an exemplary assembly of components 1100 which may be included in a network interface device in accordance with an exemplary embodiment. Assembly of components 1100 is, e.g., included in NG-RAN gNB base station 210 of system 200 of FIG. 2, N3IWF 214 of system 200 of FIG. 2, in TNGF 220 of system 200 of FIG. 2, in network interface device 303 of FIG. 3, in access network device 500 of FIG. 5 and/or in network interface device 600 of FIG. 6, in accordance with an exemplary embodiment.

The components in the assembly of components 1100 can, and in some embodiments are, implemented fully in hardware within a processor, e.g., processor 602, e.g., as individual circuits. The components in the assembly of components 1100 can, and in some embodiments are, implemented fully in hardware within the assembly of hardware components 608, e.g., as individual circuits corresponding to the different components. In other embodiments some of the components are implemented, e.g., as circuits, within processor 602 with other components being implemented, e.g., as circuits within assembly of components 608, external to and coupled to the processor 602. As should be appreciated the level of integration of components on the processor and/or with some components being external to the processor may be one of design choice. Alternatively, rather than being implemented as circuits, all or some of the components may be implemented in software and stored in the memory 610 of the network interface device 600, with the components controlling operation of network interface device 600 to implement the functions corresponding to the components when the components are executed by a processor e.g., processor 602. In some such embodiments, the assembly of components 1100 is included in the memory 610 as part of an assembly of software components 630. In still other embodiments, various components in assembly of components 1100 are implemented as a combination of hardware and software, e.g., with another circuit external to the processor providing input to the processor 602 which then under software control operates to perform a portion of a component's function.

When implemented in software the components include code, which when executed by a processor, e.g., processor 602, configure the processor to implement the function corresponding to the component. In embodiments where the assembly of components 1100 is stored in the memory 610, the memory 610 is a computer program product comprising a computer readable medium comprising code, e.g., individual code for each component, for causing at least one computer, e.g., processor 602, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 11 control and/or configure the network interface device 600 or elements therein such as the processor 602, to perform the functions of corresponding steps illustrated and/or described in the method of one or more of the flowcharts, signaling diagrams and/or described with respect to any of the Figures. Thus, the assembly of components 1100 includes various components that perform functions of corresponding one or more described and/or illustrated steps of an exemplary method, e.g., steps of the method of signaling diagram 300 of FIG. 3.

Assembly of components 1100 includes a component configured to operate the network interface device to receive a message including an initial registration request message including UE capability information, said UE capability information indicating whether or not the UE supports path switching of MA PDU sessions between N3GPP access paths, a component 1104 configured to select and AMF, from a plurality of AMFs, as a hosting AMF, e.g., based on access network parameters and local policy, and a component 1106 configured to send the received initial registration request message including the UE capability information to the selected AMF.

Assembly of components 1100 further includes a component 1108 configured to receive a registration accept message from an AMF, said registration accept message including a globally unique AMF identifier (GUAMI) and information indicating whether or not the AMF identified by the GUAMI support path switching of MA PDU sessions between N3GPP access paths, and a component 1110 configured to send a forwarded copy of the received registration accept message from the AMF, said registration accept message including a globally unique AMF identifier (GUAMI) and information indicating whether or not the AMF identified by the GUAMI support path switching of MA PDU sessions between N3GPP access paths, to a UE.

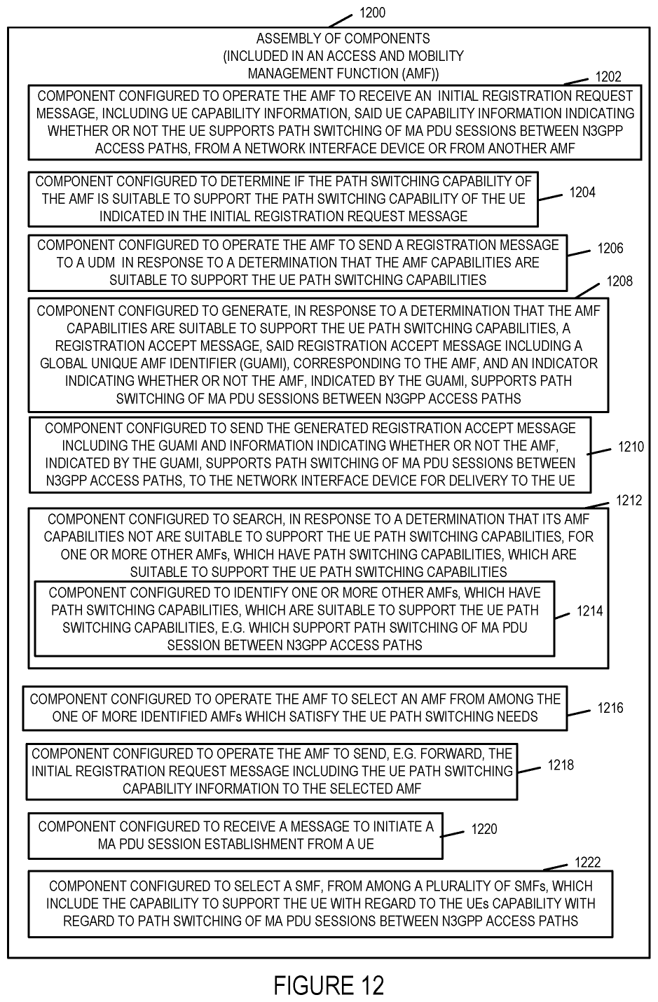

FIG. 12 is a drawing of an exemplary assembly of components which may be included in an access and mobility management function (AMF) in accordance with an exemplary embodiment. Assembly of components 1200 is, e.g., included in AMF 1 221 of system 200 of FIG. 2, AMF 2 222 of system 200 of FIG. 2, in AMF 1 221 of FIG. 3, in AMF 2 222 of FIG. 3, and/or in AMF 700 of FIG. 7, in accordance with an exemplary embodiment.

The components in the assembly of components 1200 can, and in some embodiments are, implemented fully in hardware within a processor, e.g., processor 702, e.g., as individual circuits. The components in the assembly of components 1200 can, and in some embodiments are, implemented fully in hardware within the assembly of hardware components 706, e.g., as individual circuits corresponding to the different components. In other embodiments some of the components are implemented, e.g., as circuits, within processor 702 with other components being implemented, e.g., as circuits within assembly of components 706, external to and coupled to the processor 702. As should be appreciated the level of integration of components on the processor and/or with some components being external to the processor may be one of design choice. Alternatively, rather than being implemented as circuits, all or some of the components may be implemented in software and stored in the memory 708 of the AMF 700, with the components controlling operation of AMF 700 to implement the functions corresponding to the components when the components are executed by a processor e.g., processor 702. In some such embodiments, the assembly of components 1200 is included in the memory 708 as part of an assembly of software components 720. In still other embodiments, various components in assembly of components 1200 are implemented as a combination of hardware and software, e.g., with another circuit external to the processor providing input to the processor 702 which then under software control operates to perform a portion of a component's function.

When implemented in software the components include code, which when executed by a processor, e.g., processor 702, configure the processor to implement the function corresponding to the component. In embodiments where the assembly of components 1200 is stored in the memory 708, the memory 708 is a computer program product comprising a computer readable medium comprising code, e.g., individual code for each component, for causing at least one computer, e.g., processor 702, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 12 control and/or configure the AMF 700 or elements therein such as the processor 702, to perform the functions of corresponding steps illustrated and/or described in the method of one or more of the flowcharts, signaling diagrams and/or described with respect to any of the Figures. Thus, the assembly of components 1200 includes various components that perform functions of corresponding one or more described and/or illustrated steps of an exemplary method, e.g., steps of the method of signaling diagram 300 of FIG. 3.

Assembly of components 1200 includes a component 1202 configured to operate the AMF to receive an initial registration request message, including UE capability information, said UE capability information indicating whether or not the UE supports path switching of MA PDU sessions between N3GPP access paths, from a network interface device from another AMF, a component 1204 configured to determine if the path switching capability of the AMF is suitable to support the path switching capability of the UE indicated in the initial registration request message, a component 1206 configured to operate the AMF to send a registration message to a UDM to register the UE, and associate the UE with the AMF, in response to determination that the AMF capabilities are suitable to support the path switching capability of the UE indicated in the received initial registration request message, a component 1208 configured to generate, in response to a determination that the AMF capabilities are suitable to support the UE path switching capabilities, a registration accept message, said registration accept message including a globally unique AMF identifier (GUAMI), corresponding to the AMF, and an indicator indicating whether or not the AMF, indicated by the GUAMI, supports path switching of MA PDU sessions between N3GPP access paths, and a component 1210 configured to send the generated registration accept message including the GUAMI and the information indicating whether or not the AMF supports path switching of MA PDU sessions between N3GPP access paths, to the network interface device for delivery to the UE.

Assembly of components 1200 further includes a component 1212 configured to search, in response to a determination that its AMF capabilities are not suitable to support the UE path switching capabilities, for one or more other AMFs, which have path switching capabilities, which are suitable to support the UE path switching capabilities. Component 1212 includes a component 1214 configured to identify one or more other AMFs, which have the path switching capabilities which are suitable to support the UE path switching capabilities, e.g., which support path switching of MA PDU sessions between N3GPP access paths. Assembly of components 1200 further includes a component 1216 configured to operate the AMF to select an AMF from among the one or more identified AMFs which satisfy the UE path switching needs, a component 1218 configured to operate the AMF to send, e.g., forward the received initial registration request message including the UE path switching capability information to the selected AMF. Assembly of components 1200 further includes a component 1220 configured to operate the AMF to receive a message to initiate a MA PDU session establishment from a UE, and component 1222 configured to select, a SMF, from among a plurality of SMFs, which include the capability to support the UEs capability with regard to path switching of MA PDU sessions between N3GPP access paths.

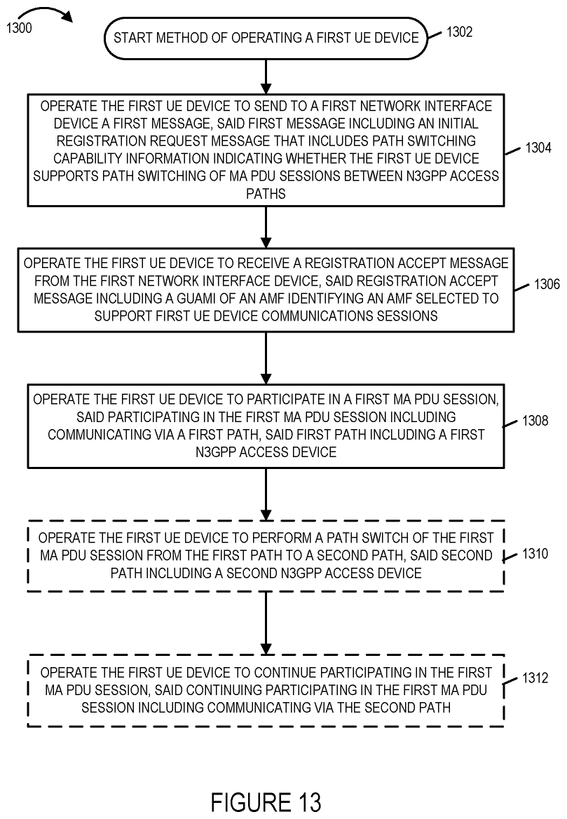

FIG. 13 is flowchart 1300 of an exemplary method of operating a first user equipment (UE) device, in accordance with an exemplary embodiment. The first UE device implementing the method of flowchart 1300 is, e.g., any of UE 202 of FIG. 2 or FIG. 3, UE 400 of FIG. 4, UE 951 of FIG. 9 and/or a UE including assembly of components 1000 of FIG. 10. Operation of the exemplary method starts in step 1302, in which the first UE device is powered on and initialized. Operation proceeds from step 1302 to step 1304.

In step 1304 the first UE device is operated to send to a first network interface device (303) (e.g., a 3GPP Next Generation—Radio Access network (NG-RAN) device, e.g., a gNB, a non-3GPP Interworking Function (N3IWF) or a Trusted Network Gateway Function (TNGF)) a first message, said first message including an initial registration request message that includes path switching capability information indicating whether the first UE device supports path switching of MA PDU sessions between N3GPP access paths.

In some embodiments, the initial registration request message includes a message type indicator indicating an initial registration type. In some embodiments, the path switching capability information included in the initial registration request message indicates that the first UE device supports path switching of MA PDU sessions between N3GPP access paths. In some embodiments, the initial registration request message is included in the first message as part of a payload of said first message, the content of the initial registration message not being fully accessible to the first network interface device but being accessible to one or more AMFs to which the first network interface device sends the initial registration request message.

In some embodiments, the first network interface device (e.g., device 303) is a 3GPP Next Generation—Radio Access Network (NG-RAN) device, e.g., NG-RAN 210. In some such embodiments, the first network interface device is a gNB base station. In some embodiments, the first network interface device is a non 3GPP Interworking Function (N3IWF), e.g., N3IWF 214. In some embodiments, the first network interface device is a Trusted Network Gateway Function (TNGF), e.g., TNGF 220. Operation proceeds from step 1304 to step 1306.

In step 1306 the first UE device is operated to receive (in response to the initial registration request message) a registration accept message from the first network interface device, said registration accept message including a GUAMI of an AMF identifying an AMF selected to support first UE device communications sessions. In some embodiments, the registration accept message includes AMF switching capability information indicating the path switching capability of the identified AMF (i.e., the AMF identified by the GUAMI included in the registration accept message). In some embodiments, the AMF path switching capability information is communicated via a mandatory field of the registration accept message.

In some embodiments, the path switching capability information in the registration accept message indicates that the identified AMF (e.g., AMF 221) does not support path switching of MA PDU sessions between N3GPP access paths.

In some embodiments, the path switching capability information in the registration accept message indicates that the identified AMF (e.g., AMF 222) supports path switching of MA PDU sessions between N3GPP access paths. Operation proceeds from step 1306 to step 1308.

In step 1308 the first UE device is operated to participate in a first MA PDU session, said participating in a first MA PDU session including communicating via a first path (a first access path), said first path including a first N3GPP access device, e.g., AP 212 of N3GPP access network #A 206. Operation may, and sometimes does (e.g., for an embodiment in which the first UE 202 and the AMF 222 support N3GPP MA PDU path switching), proceed from step 1308 to step 1310.

In step 1310, the first UE device is operated to perform a path switch of the first MA PDU session from the first path to a second path (a second access path), said second path including a second N3GPP access device, e.g., TNAP 218 of N3GPP access network #B 208. Operation proceeds from step 1310 to step 1312.

In step 1312 the first UE device is operated to continue participating in the first MA PDU session, said continuing participating in the first MA PDU session including communicating via the second path.

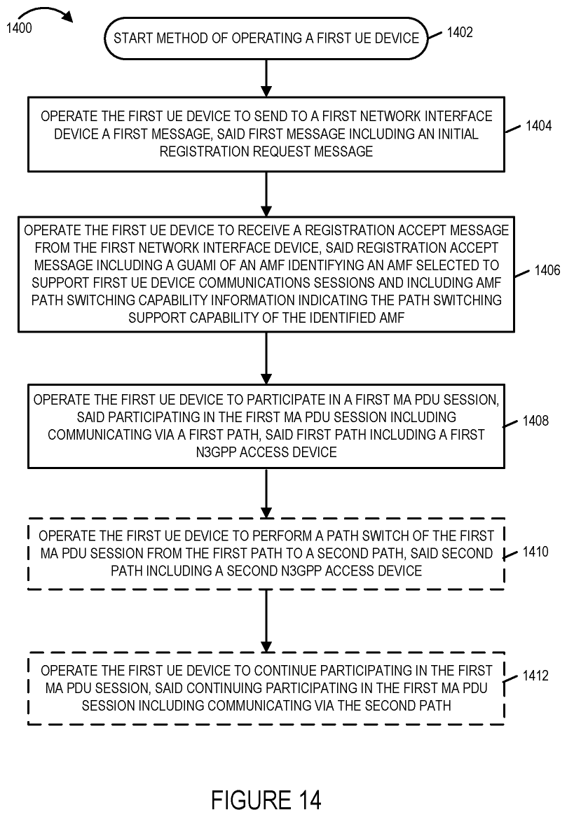

FIG. 14 is a flowchart 1400 of an exemplary method of operating a first user equipment (UE) device, in accordance with an exemplary embodiment. The first UE device implementing the method of flowchart 1300 is, e.g., any of UE 202 of FIG. 2 or FIG. 3, UE 400 of FIG. 4, UE 951 of FIG. 9 and/or a UE including assembly of components 1000 of FIG. 10. Operation of the exemplary method starts in step 1402, in which the first UE device is powered on and initialized. Operation proceeds from step 1402 to step 1404.

In step 1404 the first UE device is operated to send, to a first network interface device (303) (e.g., a 3GPP Next Generation—Radio Access network (NG-RAN) device, e.g., a gNB, a non-3GPP Interworking Function (N3IWF) or a Trusted Network Gateway Function (TNGF)), a first message, said first message including an initial registration request message. In some embodiments, the first network interface device (e.g., device 303) is a 3GPP Next Generation—Radio Access Network (NG-RAN) device, e.g., NG-RAN 210. In some such embodiments, the first network interface device is a gNB base station. In some embodiments, the first network interface device is a non 3GPP Interworking Function (N3IWF), e.g., N3IWF 214. In some embodiments, the first network interface device is a Trusted Network Gateway Function (TNGF), e.g., TNGF 220.

In some embodiments, said initial registration request message includes path switching capability information indicating whether the first UE device supports path switching of MA PDU sessions between N3GPP access paths. Operation proceeds from step 1404 to step 1406.

In step 1406 the first UE device is operated to receive (in response to the initial registration request) a registration accept message from the first network interface device, said registration accept message including a GUAMI of an AMF identifying an AMF selected to support first UE device communications sessions and including AMF path switching capability information indicating the path switching support capability of the identified AMF (i.e., the AMF identified by the GUAMI in the registration accept message).

In some embodiments, the AMF path switching capability information is communicated via a mandatory field.

In some embodiments, the path switching capability information in the registration accept message indicates that the identified AMF (e.g., AMF 221) does not support path switching of MA PDU session between N3GPP access paths.

In some embodiments, the path switching capability information in the registration accept message indicates that the identified AMF (e.g., AMF 222) does support path switching of MA PDU session between N3GPP access paths. Operation proceeds from step 1406 to step 1408.

In step 1408 the first UE device is operated to participate in a first MA PDU session, said participating in a first MA PDU session including communicating via a first path (a first access path), said first path including a first N3GPP access device, e.g., AP 212 of N3GPP access network #A 206. Operation may, and sometimes does (e.g., for an embodiment in which the first UE 202 and the identified AMF 222 support N3GPP MA PDU path switching), proceed from step 1408 to step 1410.

In step 1410, the first UE device is operated to perform a path switch of the first MA PDU session from the first path to a second path (a second access path), said second path including a second N3GPP access device, e.g., TNAP 218 of N3GPP access network #B 208. Operation proceeds from step 1410 to step 1412.

In step 1412 the first UE device is operated to continue participating in the first MA PDU session, said continuing participating in the first MA PDU session including communicating via the second path.

### First Numbered List of Exemplary Method Embodiments

Method Embodiment 1. A communications method, the method comprising: operating a network interface device (303) (e.g., a 3GPP Next Generation-Radio Access Network (NG-RAN) device, e.g. a gNB base station, a non-3GPP Interworking Function (N3IWF) or a Trusted Network Gateway Function (TNGF)) to receive (308) a first message from a first User Equipment (UE) (202) (e.g., a first UE device), said first message including an initial registration request message that includes path switching capability information indicating whether the first UE supports path switching of MA PDU sessions between N3GPP access paths; operating the network interface device, in response to receiving the first message, to make (310) an initial AMF selection to select a first AMF (221) to serve as a hosting AMF for the first UE (202); and operating the network interface device to communicate (312) the initial registration request message to the first AMF (221).

Method Embodiment 1A. The method of Method Embodiment 1, wherein said initial registration message includes a message type indicator indicating an initial registration type.

Method Embodiment 1B. The method of Method Embodiment 1A, wherein said initial registration request message is included in said first message as part of a payload of said first message, the content of said initial registration message not being fully accessible to the network interface device but being accessible to one or more AMFs to which the initial registration message is communicated.

Method Embodiment 2. The method of Method Embodiment 1, further comprising: operating the first AMF to determine (318) if the hosting AMF can support a level of path switching capability the first UE supports as indicated by the path switching capability information included in said initial registration request message.

Method Embodiment 3. The method of Method Embodiment 2, wherein said network interface device does not consider the path switching capability of the first UE when making the initial AMF selection (e.g., because it does not have access to the path switching information included in the initial registration request message but which can be accessed by an AMF).

Method Embodiment 4. The method of Method Embodiment 2, wherein the path switching capability information included in the initial registration request message indicates that the first UE supports path switching of MA PDU sessions between N3GPP access paths; wherein the first AMF does not support path switching of MA PDU sessions between N3GPP access paths; wherein operating the first AMF to determine (318) if the hosting AMF can support a level of path switching capability the first UE supports as indicated by the path switching capability information included in said initial registration request message includes determining that the first AMF can not support the level of path switching capability the first UE supports; and wherein the method further comprises: operating the first AMF to select (320) a second AMF (222) which can support the level of path switching capability the first UE supports to serve as the host for the first UE (e.g., AMF 2 supports path switching of MA PDU sessions between N3GPP access paths unlike AMF 1).

Method Embodiment 5. The method of Method Embodiment 4, further comprising: operating the first AMF to send (322) the initial registration request message path switching capability information indicating that the first UE supports path switching of MA PDU sessions between N3GPP access paths to the second AMF.

Method Embodiment 6. The method of Method Embodiment 5, further comprising: operating the second AMF (AMF 2) to receive (326) the initial registration request message corresponding to the first UE; and operating the second AMF (AMF 2) to send (336) a registration accept message (e.g., after determining that it supports the level of path switching supported by the first UE) to the network interface device indicating that the second AMF accepts the initial registration request made by the first UE.

Method Embodiment 6A. The method of Method Embodiment 6, wherein said registration accept message includes the GUAMI (Globally Unique AMF identifier) of the second AMF and an indicator indicating that the second AMF supports path switching of MA PDU sessions between N3GPP access paths.

Method Embodiment 7. The method of Method Embodiment 6, further comprising: operating the second AMF to select (364) a SMF (SMF 2) which supports path switching of MA PDU sessions between N3GPP access paths to be used to support first UE communications (e.g., with the selection being made from a plurality of available SMFs some of which do not support path switching (e.g., SMF 1) and some of which support path switching (e.g., SMF 2).

Method Embodiment 7A. The method of Method Embodiment 7, further comprising: operating the second AMF (AMF 2) to send (366) a create SM context request to the selected SMF to create SM context for the first UE at the selected SMF (SMF 2).

Method Embodiment 8. The method of Method Embodiment 7, further comprising: operating the network interface device to send (346) a registration accept message to the first UE including the GUAMI of the second AMF and information indicating that the AMF supports path switching of MA PDU sessions between N3GPP access paths; and operating the second AMF to receive (362) an initiate MA PDU session establishment message from the first UE.

Method Embodiment 8A. The method of Method Embodiment 8, wherein sending (366) the create SM content request is sent by the selected SMF as part of establishing an MA PDU session for the first UE in response to the initiate MA PDU session establishment message received from the first UE.

Method Embodiment 9. The method of Method Embodiment 8, further comprising: operating the UE to communicate with another network interface device via a MA PDU path established in response to the initiate MA PDU session establishment message.

### First Numbered List of Exemplary System Embodiments

System Embodiment 1. A communications system (200) comprising: a network interface device (303 or 214 or 220 or 210 or 600) (e.g., a 3GPP Next Generation-Radio Access Network (NG-RAN) device, e.g. a gNB base station, a non-3GPP Interworking Function (N3IWF) or a Trusted Network Gateway Function (TNGF)) including: a first receiver (612); a first transmitter (618); and a first processor (602) configured to: operate the network interface device (303) to receive (308) (via the first receiver) a first message from a first User Equipment (UE) (202) (e.g., a first UE device), said first message including an initial registration request message that includes path switching capability information indicating whether the first UE supports path switching of MA PDU sessions between N3GPP access paths; operate the network interface device (303), in response to receiving the first message, to make (310) an initial AMF selection to select a first AMF (221) to serve as a hosting AMF for the first UE (202); and operate the network interface device (303) to communicate (312) (via the first transmitter) the initial registration request message to the first AMF (221).

System Embodiment 1A. The communications system (200) of System Embodiment 1, wherein said initial registration message includes a message type indicator indicating an initial registration type.

System Embodiment 1B. The communications system (200) of System Embodiment 1A, wherein said initial registration request message is included in said first message as part of a payload of said first message, the content of said initial registration message not being fully accessible to the network interface device (303) but being accessible to one or more AMFs (221, 222) to which the initial registration message is communicated.

System Embodiment 2. The communications system (200) of System Embodiment 1, further comprising: said first AMF (221 or 700) including: a second processor (702) configured to: operate the first AMF (221) to determine (318) if the hosting AMF can support a level of path switching capability the first UE (202) supports as indicated by the path switching capability information included in said initial registration request message.

System Embodiment 3. The communications system (200) of System Embodiment 2, wherein said network interface device (303) does not consider the path switching capability of the first UE (202) when making the initial AMF selection (e.g., because it does not have access to the path switching information included in the initial registration request message but which can be accessed by an AMF).

System Embodiment 4. The communications system (200) of System Embodiment 2, wherein the path switching capability information included in the initial registration request message indicates that the first UE (202) supports path switching of MA PDU sessions between N3GPP access paths; wherein the first AMF (221) does not support path switching of MA PDU sessions between N3GPP access paths; and wherein said second processor (702 of AMF 221) is further configured to: determine that the first AMF (221) can not support the level of path switching capability the first UE (202) supports, as part of being configured to operate the first AMF (221) to determine (318) if the hosting AMF can support a level of path switching capability the first UE (202) supports as indicated by the path switching capability information included in said initial registration request message; operate the first AMF (221) to select (320) a second AMF (222) which can support the level of path switching capability the first UE supports to serve as the host for the first UE (e.g., AMF 2 (222) supports path switching of MA PDU sessions between N3GPP access paths unlike AMF 1 (221)).

System Embodiment 5. The communications system (200) of System Embodiment 4, wherein said first AMF (221) further includes a second transmitter (714 of AMF 221) configured to: operate the first AMF (221) to send (322) (via the second transmitter 714) initial registration request message path switching capability information indicating that the first UE supports path switching of MA PDU sessions between N3GPP access paths to the second AMF.

System Embodiment 6. The communications system (200) of System Embodiment 5, further comprising: said second AMF (222 or 700) including: a second receiver (712 of 222); a third transmitter (714 of 222); and a third processor (702 of 222) configured to: operate the second AMF (AMF 2 222) to receive (326) (via the second receiver (712 of 222) the initial registration request message corresponding to the first UE (202); and operate the second AMF (AMF 2 222) to send (336) (via the third transmitter (714 of 222) a registration accept message (e.g., after determining that it supports the level of path switching supported by the first UE) to the network interface device indicating that the second AMF (222) accepts the initial registration request made by the first UE (202).

System Embodiment 6A. The communications system (200) of System Embodiment 6, wherein said registration accept message includes the GUAMI (Globally Unique AMF identifier) of the second AMF (222) and an indicator indicating that the second AMF (222) supports path switching of MA PDU sessions between N3GPP access paths.

System Embodiment 7. The communications system (200) of System Embodiment 6, wherein said third processor (702 of 222) is further configured to: operate the second AMF (222) to select (364) a SMF (SMF 2 224) which supports path switching of MA PDU sessions between N3GPP access paths to be used to support first UE communications (e.g., with the selection being made from a plurality of available SMFs some of which do not support path switching (e.g. SMF 1 225) and some of which support path switching (e.g. SMF 2 224).

System Embodiment 7A. The communications system (200) of System Embodiment 7, wherein said third processor (702 of 222) is further configured to: operate the second AMF (AMF 2 222) to send (366) (via the third transmitter (714 of 222) a create SM context request to the selected SMF (224) to create SM context for the first UE (202) at the selected SMF (SMF 2 224).

System Embodiment 8. The communications system (200) of System Embodiment 7, wherein said first processor (602) is further configured to:
operate the network interface device (303) to send (346) a registration accept message to the first UE (202) including the GUAMI of the second AMF (222) and information indicating that the second AMF (222) supports path switching of MA PDU sessions between N3GPP access paths; and wherein said third processor (702 of 222) is further configured to: operate the second AMF (222) to receive (362) an initiate MA PDU session establishment message from the first UE (202).

System Embodiment 8A. The communications system (200) of System Embodiment 8, wherein the create SM content request is sent by the selected SMF (224) as part of establishing an MA PDU session for the first UE (202) in response to the initiate MA PDU session establishment message received from the first UE (202).

System Embodiment 9. The communications system (200) of System Embodiment 8, further comprising: said first UE (202 or 400) including: a first wireless receiver (438); a first wireless transmitter (440); and a fourth processor (402) configured to: operating the first UE (202) to communicate (e.g., send signal via the first wireless transmitter (438) and/or receive signals via the first wireless transmitter (440)) with another network interface device via a MA PDU path established in response to the initiate MA PDU session establishment message.

### First Numbered List of Exemplary Non-Transitory Computer Readable Medium Embodiments

Non-Transitory Computer Readable Medium Embodiment 1. A non-transitory computer readable medium (610) including computer executable instructions which when executed by a processor (602) of a network interface device (303 or 214 or 220 or 210 or 600 or 602) cause the network interface device to perform the steps of: operating the network interface device (e.g., a 3GPP Next Generation-Radio Access Network (NG-RAN) device, e.g. a gNB base station, a non-3GPP Interworking Function (N3IWF) or a Trusted Network Gateway Function (TNGF)) to receive (308) a first message from a first User Equipment (UE) (202) (e.g., a first UE device), said first message including an initial registration request message that includes path switching capability information indicating whether the first UE supports path switching of MA PDU sessions between N3GPP access paths; operating the network interface device, in response to receiving the first message, to make (310) an initial AMF selection to select a first AMF (221) to serve as a hosting AMF for the first UE (202); and operating the network interface device to communicate (312) the initial registration request message to the first AMF (221).

### Second Numbered List of Exemplary Method Embodiments

Method Embodiment 1. A communications method, the method comprising: operating a network interface device (303) (e.g., a 3GPP Next Generation-Radio Access Network (NG-RAN) device, e.g., a gNB base station, a non-3GPP Interworking Function (N3IWF) or a Trusted Network Gateway Function (TNGF)) to receive (308) a first message from a first User Equipment (UE) (202) (e.g., a first UE device), said first message including an initial registration request message; and operating the network interface device to send (346) a registration accept message to the first UE including a GUAMI of an AMF identifying an AMF selected to support first UE communications sessions and including AMF path switching capability information indicating the path switching support capability of the identified AMF (i.e., the AMF identified by the GUAMI included in the registration accept message).

Method Embodiment 1A. The method of Method Embodiment 1, wherein said network interface device (303) is one of a 3GPP Next Generation-Radio Access Network (NG-RAN) device, (e.g., a gNB base station), a Non-3GPP Interworking Function (N3IWF) or a Trusted Network Gateway Function (TNGF).

Method Embodiment 1B. The method of Method Embodiment 1, wherein said AMF path switching capability information is communicated via a mandatory field.

Method Embodiment 2. The method of Method Embodiment 1, wherein the path switching capability information in the registration accept message indicates that the identified AMF does not support path switching of MA PDU sessions between N3GPP access paths.

Method Embodiment 3. The method of Method Embodiment 2, wherein the path switching capability information in the registration accept message indicates that the identified AMF supports path switching of MA PDU sessions between N3GPP access paths.

Method Embodiment 4. The method of Method Embodiment 3, further comprising: operating the identified AMF to receive (362) an initiate MA PDU session establishment message from the first UE.

Method Embodiment 5. The method of Method Embodiment 4, further comprising: operating the identified AMF (222) to select (364) a SMF (SMF 2 224) which supports path switching of MA PDU sessions between N3GPP access paths to be used to support first UE communications (e.g., with the selection being made from a plurality of available SMFs some of which do not support path switching (e.g. SMF 1 225) and some of which support path switching (e.g. SMF 2 224).

Method Embodiment 6. The communications method of Method Embodiment 5, further comprising: operating the identified AMF (AMF 2 222) to send (366) (via the third transmitter (714 of 222) a create SM context request to the selected SMF (SME 2 224) to create SM context for the first UE (202) at the selected SMF (SMF 2 224).

Method Embodiment 7. The method of Method Embodiment 6, wherein sending (366) the create SM content request is sent by the selected SMF as part of establishing an MA PDU session for the first UE in response to the initiate MA PDU session establishment message received from the first UE.

Method Embodiment 8. The method of Method Embodiment 7, further comprising: operating another network interface device to communicate with the UE via a MA PDU path established in response to the initiate MA PDU session establishment message.

### Second Numbered List of Exemplary System Embodiments

System Embodiment 1. A communications system (200) comprising: a network interface device (303 or 214 or 220 or 210 or 600) (e.g., a 3GPP Next Generation-Radio Access Network (NG-RAN) device, e.g. a gNB base station, a non-3GPP Interworking Function (N3IWF) or a Trusted Network Gateway Function (TNGF)) including: a first receiver (612); a first transmitter (618); and a first processor (602) configured to: operate the network interface device (303) to receive (308) (via the first receiver) a first message from a first User Equipment (UE) (202) (e.g., a first UE device), said first message including an initial registration request message; and operate the network interface device (303) to send (346) a registration accept message to the first UE (202) including a GUAMI of an AMF identifying an AMF (221 or 222) selected to support first UE communications sessions and including AMF path switching capability information indicating the path switching support capability of the identified AMF (i.e., the AMF identified by the GUAMI included in the registration accept message).

System Embodiment 1A. The communications system (200) of System Embodiment 1, wherein said network interface device (303) is one of a 3GPP Next Generation-Radio Access Network (NG-RAN) device, (e.g., a gNB base station) or a Trusted Network Gateway Function (TNGF).

System Embodiment 1B. The communications system (200) of System Embodiment 1, wherein said AMF path switching capability information is communicated via a mandatory field.

System Embodiment 2. The communications system (200) of System Embodiment 1, wherein the path switching capability information in the registration accept message indicates that the identified AMF (221) does not support path switching of MA PDU sessions between N3GPP access paths.

System Embodiment 3. The communications system (200) of System Embodiment 2, wherein the path switching capability information in the registration accept message indicates that the identified AMF (222) supports path switching of MA PDU sessions between N3GPP access paths.

System Embodiment 4. The communications system (200) of System Embodiment 3, further comprising: said identified AMF (222) including: a second receiver (712); and a second processor (702) configured to: operate the identified AMF (222) to receive (362) (via second receiver (712)) an initiate MA PDU session establishment message from the first UE (2020.

System Embodiment 5. The communications system (200) of System Embodiment 4, wherein said second processor (702) is further configured to: operate the identified AMF (222) to select (364) a SMF (SMF 2 224) which supports path switching of MA PDU sessions between N3GPP access paths to be used to support first UE communications (e.g., with the selection being made from a plurality of available SMFs some of which do not support path switching (e.g. SMF 1 225) and some of which support path switching (e.g. SMF 2 224).

System Embodiment 6. The communications system (200) of System Embodiment 5, wherein said identified AMF (222) further includes a second transmitter (714); and wherein said second processor (702) is further configured to: operate the identified AMF (AMF 2 222) to send (366) (via the second transmitter (714 of 222) a create SM context request to the selected SMF (SMF 2 224) to create SM context for the first UE (202) at the selected SMF (SMF 2 224).

System Embodiment 7. The communications system (200) of System Embodiment 6, wherein sending (366) the create SM content request is sent by the selected SMF (224) as part of establishing an MA PDU session for the first UE (202) in response to the initiate MA PDU session establishment message received from the first UE (202).

System Embodiment 8. The communications system (202) of System Embodiment 7, further comprising: another network interface device (303′ or 214 or 220 or 210 or 600′) including: a third receiver (612′); a third transmitter (614′); and a third processor (602′) configured to: operate said another network interface device (303′) to communicate with the UE (202) via a MA PDU path established in response to the initiate MA PDU session establishment message.

### Second Numbered List of Exemplary Non-Transitory Computer Readable Medium Embodiments

Non-Transitory Computer Readable Medium Embodiment 1.

A non-transitory computer readable medium (610) including computer executable instructions which when executed by a processor (602) of a network interface device (303 or 214 or 220 or 210 or 600 or 602) cause the network interface device to perform the steps of: operating the network interface device (e.g., a 3GPP Next Generation-Radio Access Network (NG-RAN) device, e.g., a gNB base station, a non-3GPP Interworking Function (N3IWF) or a Trusted Network Gateway Function (TNGF)) to receive (308) a first message from a first User Equipment (UE) (202) (e.g., a first UE device), said first message including an initial registration request message; and operating the network interface device to send (346) a registration accept message to the first UE including a GUAMI of an AMF identifying an AMF selected to support first UE communications sessions and including AMF path switching capability information indicating the path switching support capability of the identified AMF (i.e., the AMF identified by the GUAMI included in the registration accept message).

### Third Numbered List of Exemplary Method Embodiments

Method Embodiment 1. A method of operating a first user equipment (UE) device, the method comprising: operating (1304) the first UE device to send to a first network interface device (303) (e.g., a 3GPP Next Generation-Radio Access Network (NG-RAN) device, e.g. a gNB base station, a non-3GPP Interworking Function (N3IWF) or a Trusted Network Gateway Function (TNGF)) a first message, said first message including an initial registration request message that includes path switching capability information indicating whether the first UE device supports path switching of MA PDU sessions between N3GPP access paths; and operating (1306) the first UE device to receive (in response to the initial registration request message) a registration accept message from the first network interface device, said registration accept message including a GUAMI of an AMF identifying an AMF selected to support first UE device communications sessions.

Method Embodiment 1A. The method of Method Embodiment 1, wherein said initial registration message includes a message type indicator indicating an initial registration type.

Method Embodiment 1AA. The method of Method Embodiment 1, wherein the path switching capability information included in the initial registration request message indicates that the first UE device supports path switching of MA PDU sessions between N3GPP access paths.

Method Embodiment 1B. The method of Method Embodiment 1A, wherein said initial registration request message is included in said first message as part of a payload of said first message, the content of said initial registration message not being fully accessible to the first network interface device but being accessible to one or more AMFs to which the first network interface device (303) sends said initial registration message.

Method Embodiment 2. The method of Method Embodiment 1 wherein said first network interface device (303) is a 3GPP Next Generation-Radio Access Network (NG-RAN) device.

Method Embodiment 2A. The method of Method Embodiment 2, wherein said first network interface device is a gNB base station.

Method Embodiment 3. The method of Method Embodiment 1, wherein said first network interface device is a non 3GPP Interworking Function (N3IWF).

Method Embodiment 4. The method of Method Embodiment 1, wherein said first network interface device is a Trusted Network Gateway Function (TNGF)).

Method Embodiment 5. The method of Method Embodiment 1, wherein said registration accept message includes AMF path switching capability information indicating the path switching support capability of the identified AMF (i.e., the AMF identified by the GUAMI included in the registration accept message).

Method Embodiment 6. The method of Method Embodiment 5, wherein said AMF path switching capability information is communicated via a mandatory field of said registration accept message.

Method Embodiment 7. The method of Method Embodiment 5, wherein the path switching capability information in the registration accept message indicates that the identified AMF (221) does not support path switching of MA PDU sessions between N3GPP access paths.

Method Embodiment 8. The method of Method Embodiment 5, wherein the path switching capability information in the registration accept message indicates that the identified AMF (222) supports path switching of MA PDU sessions between N3GPP access paths.

Method Embodiment 9. The method of Method Embodiment 8, further comprising: operating (1306) the first UE device to participate in a first MA PDU session, said participating in a first MA PDU session including communications via a first path (first access path), said first path including a first N3GPP access device (e.g., AP 212); operating (1308) the first UE device to perform a path switch of the first MA PDU session from the first path to a second path (second access path), said second path including a second N3GPP access device (e.g., TNAP 218); and operating (1310) the first UE device to continue participating in the first MA PDU session, said continuing participating in the first MA PDU session including communications via the second path.

Method Embodiment 10. The method of Method Embodiment 9, wherein said identified AMF (222) supports the path switching between the first and second paths.

### First Numbered List of Exemplary Apparatus Embodiments

Apparatus Embodiment 1. A first user equipment (UE) device (202 or 400 or 951) comprising: a wireless transmitter (426 or 440 or 454); a wireless receiver (424 or 438 or 452); and a processor (402) configured to: operate (1304) the first UE device to send (via the wireless transmitter) to a first network interface device (303) (e.g., a 3GPP Next Generation-Radio Access Network (NG-RAN) device, e.g. a gNB base station, a non-3GPP Interworking Function (N3IWF) or a Trusted Network Gateway Function (TNGF)) a first message, said first message including an initial registration request message that includes path switching capability information indicating whether the first UE device supports path switching of MA PDU sessions between N3GPP access paths; and operate (1306) the first UE device to receive (via the wireless receiver) (in response to the initial registration request message) a registration accept message from the first network interface device, said registration accept message including a GUAMI of an AMF identifying an AMF (221 or 222) selected to support first UE device communications sessions.

Apparatus Embodiment 1A. The first UE device of Apparatus Embodiment 1, wherein said initial registration message includes a message type indicator indicating an initial registration type.

Apparatus Embodiment 1AA. The first UE device of Apparatus Embodiment 1, wherein the path switching capability information included in the initial registration request message indicates that the first UE device supports path switching of MA PDU sessions between N3GPP access paths.

Apparatus Embodiment 1B. The first UE device of Apparatus Embodiment 1A, wherein said initial registration request message is included in said first message as part of a payload of said first message, the content of said initial registration message not being fully accessible to the first network interface device but being accessible to one or more AMFs to which the first network interface device (303) sends said initial registration message.

Apparatus Embodiment 2. The first UE device of Apparatus Embodiment 1 wherein said first network interface device (303) is a 3GPP Next Generation-Radio Access Network (NG-RAN) device (210).

Apparatus Embodiment 2A. The first UE device of Apparatus Embodiment 2, wherein said first network interface device (303) is a gNB base station (210).

Apparatus Embodiment 3. The first UE device of Apparatus Embodiment 1, wherein said first network interface device (303) is a non 3 GPP Interworking Function (N3IWF) (214).

Apparatus Embodiment 4. The first UE device of Apparatus Embodiment 1, wherein said first network interface device (303) is a Trusted Network Gateway Function (TNGF)) (220).

Apparatus Embodiment 5. The first UE device of Apparatus Embodiment 1, wherein said registration accept message includes AMF path switching capability information indicating the path switching support capability of the identified AMF (i.e., the AMF identified by the GUAMI included in the registration accept message).

Apparatus Embodiment 6. The first UE device of Apparatus Embodiment 5, wherein said AMF path switching capability information is communicated via a mandatory field of said registration accept message.

Apparatus Embodiment 7. The first UE device of Apparatus Embodiment 5, wherein the path switching capability information in the registration accept message indicates that the identified AMF (221) does not support path switching of MA PDU sessions between N3GPP access paths.

Apparatus Embodiment 8. The first UE device of Apparatus Embodiment 5, wherein the path switching capability information in the registration accept message indicates that the identified AMF (222) supports path switching of MA PDU sessions between N3GPP access paths.

Apparatus Embodiment 9. The first UE device of Apparatus Embodiment 8, wherein said processor (402) is further configured to: operate (1306) the first UE device to participate in a first MA PDU session, said participating in a first MA PDU session including communications via a first path (first access path), said first path including a first N3GPP access device (e.g., AP 212); operate (1308) the first UE device to perform a path switch of the first MA PDU session from the first path to a second path (second access path), said second path including a second N3GPP access device (e.g., TNAP 218); and operate (1310) the first UE device to continue participating in the first MA PDU session, said continuing participating in the first MA PDU session including communications via the second path.

Apparatus Embodiment 10. The first UE device of Apparatus Embodiment 9, wherein said identified AMF (222) supports the path switching between the first and second paths.

### Third Numbered List of Exemplary Non-Transitory Computer Readable Medium Embodiments

Non-Transitory Computer Readable Medium Embodiment 1. A non-transitory computer readable medium (412) including computer executable instructions which when executed by a processor (402) of a first user equipment (UE) device (202 or 400 or 951) cause the first UE device to perform the steps of: operating (1304) the first UE device to send to a first network interface device (303) (e.g., a 3GPP Next Generation-Radio Access Network (NG-RAN) device, e.g. a gNB base station, a non-3GPP Interworking Function (N3IWF) or a Trusted Network Gateway Function (TNGF)) a first message, said first message including an initial registration request message that includes path switching capability information indicating whether the first UE device supports path switching of MA PDU sessions between N3GPP access paths; and operating (1306) the first UE device to receive (in response to the initial registration request message) a registration accept message from the first network interface device, said registration accept message including a GUAMI of an AMF identifying an AMF selected to support first UE device communications sessions.

### Fourth Numbered List of Exemplary Method Embodiments

Method Embodiment 1. A method of operating a first user equipment (UE) device (202), the method comprising: operating (1404) the first UE device to send (via the wireless transmitter) to a first network interface device (303) (e.g., a 3GPP Next Generation-Radio Access Network (NG-RAN) device, e.g., a gNB base station, a non-3GPP Interworking Function (N3IWF) or a Trusted Network Gateway Function (TNGF)) a first message, said first message including an initial registration request message; and operating (1406) the first UE device to receive (via the wireless receiver) (in response to the initial registration request) a registration accept message including a GUAMI of an AMF (221 or 222) identifying an AMF (221 or 222), selected to support first UE device communications sessions, and including AMF path switching capability information indicating the path switching support capability of the identified AMF (i.e., the AMF identified by the GUAMI included in the registration accept message).

Method Embodiment 1A. The method of Method Embodiment 1, wherein said initial registration request message includes path switching capability information indicating whether the first UE device supports path switching of MA PDU sessions between N3GPP access paths.

Method Embodiment 2. The method of Method Embodiment 1, wherein said first network interface device (303) is a 3GPP Next Generation-Radio Access Network (NG-RAN) device, e.g., a gNB base station.

Method Embodiment 3. The method of Method Embodiment 1, wherein said first network interface device is a non-3GPP Interworking Function (N3IWF).

Method Embodiment 4. The method of Method Embodiment 1, wherein said first network interface device is a Trusted Network Gateway Function (TNGF)).

Method Embodiment 5. The method of Method Embodiment 1, wherein said AMF path switching capability information is communicated via a mandatory field.

Method Embodiment 6. The method of Method Embodiment 1, wherein the path switching capability information in the registration accept message indicates that the identified AMF (221) does not support path switching of MA PDU sessions between N3GPP access paths.

Method Embodiment 7. The method of Method Embodiment 1, wherein the path switching capability information in the registration accept message indicates that the identified AMF (222) supports path switching of MA PDU sessions between N3GPP access paths.

Method Embodiment 8. The method of Method Embodiment 7, wherein said initial registration request message includes path switching capability information indicating whether the first UE device supports path switching of MA PDU sessions between N3GPP access paths.

Method Embodiment 8A. The method of Method Embodiment 8, wherein said path switching capability information in the initial registration request message indicates that the first UE device supports path switching of MA PDU sessions between N3GPP access paths.

Method Embodiment 9. The method of Method Embodiment 7, further comprising: operating (1408) the first UE device to participate in a first MA PDU session, said participating including communications via a first path (first access path), said first path including a first N3GPP access device (e.g., AP 212); operating (1410) the first UE device to perform a path switch of the first MA PDU session from the first path to a second path (second access path), said second path including a second N3GPP access device (e.g., TNAP 218); and operating (1412) the first UE device to continue participating in the first MA PDU session, said continuing participating in the first MA PDU session including communications via the second path.

Method Embodiment 10. The method of Method Embodiment 9, wherein said identified AMF (222) supports the path switching between the first and second paths.

### Second Numbered List of Exemplary Apparatus Embodiments

Apparatus Embodiment 1. A first user equipment (UE) device (202 or 400 or 951) comprising: a wireless transmitter (426 or 440 or 454); a wireless receiver (424 or 438 or 452); and a processor (402) configured to: operate (1404) the first UE device to send to a first network interface device (303) (e.g., a 3GPP Next Generation-Radio Access Network (NG-RAN) device, e.g., a gNB base station, a non-3GPP Interworking Function (N3IWF) or a Trusted Network Gateway Function (TNGF)) a first message, said first message including an initial registration request message; and operate (1406) the first UE device to receive (in response to the initial registration request) a registration accept message including a GUAMI of an AMF (221 or 222) identifying an AMF (221 or 222), selected to support first UE device communications sessions, and including AMF path switching capability information indicating the path switching support capability of the identified AMF (i.e., the AMF identified by the GUAMI included in the registration accept message).

Apparatus Embodiment 1A. The first UE device of Apparatus Embodiment 1, wherein said initial registration request message includes path switching capability information indicating whether the first UE device supports path switching of MA PDU sessions between N3GPP access paths.

Apparatus Embodiment 2. The first UE device of Apparatus Embodiment 1, wherein said first network interface device (303) is a 3GPP Next Generation-Radio Access Network (NG-RAN) device (210), e.g., a gNB base station.

Apparatus Embodiment 3. The first UE device of Apparatus Embodiment 1, wherein said first network interface device (303) is a non-3GPP Interworking Function (N3IWF) (214).

Apparatus Embodiment 4. The first UE device of Apparatus Embodiment 1, wherein said first network interface device (303) is a Trusted Network Gateway Function (TNGF) (220).

Apparatus Embodiment 5. The first UE device of Apparatus Embodiment 1, wherein said AMF path switching capability information is communicated via a mandatory field.

Apparatus Embodiment 6. The first UE device of Apparatus Embodiment 1, wherein the path switching capability information in the registration accept message indicates that the identified AMF (221) does not support path switching of MA PDU sessions between N3GPP access paths.

Apparatus Embodiment 7. The first UE device of Apparatus Embodiment 1, wherein the path switching capability information in the registration accept message indicates that the identified AMF (222) supports path switching of MA PDU sessions between N3GPP access paths.

Apparatus Embodiment 8. The UE device of Apparatus Embodiment 7, wherein said initial registration request message includes path switching capability information indicating whether the first UE device supports path switching of MA PDU sessions between N3GPP access paths.

Apparatus Embodiment 8A. The UE device of Apparatus Embodiment 8, wherein said path switching capability information in the initial registration request message indicates that the first UE device supports path switching of MA PDU sessions between N3GPP access paths.

Apparatus Embodiment 9. The first UE device of Apparatus Embodiment 7, wherein said processor (402) is further configured to: operate (1408) the first UE device to participate in a first MA PDU session, said participating including communications via a first path (first access path), said first path including a first N3GPP access device (e.g., AP 212); operate (1410) the first UE device to perform a path switch of the first MA PDU session from the first path to a second path (second access path), said second path including a second N3GPP access device (e.g., TNAP 218); and operating (1412) the first UE device to continue participating in the first MA PDU session, said continuing participating in the first MA PDU session including communications via the second path.

Apparatus Embodiment 10. The first UE device of Apparatus Embodiment 9, wherein said identified AMF (222) supports the path switching between the first and second paths.

### Fourth Numbered List of Exemplary Non-Transitory Computer Readable Medium Embodiments

Non-Transitory Computer Readable Medium Embodiment 1. A non-transitory computer readable medium (412) including computer executable instructions which when executed by a processor (402) of a first user equipment (UE) device (202 or 400 or 951) cause the first UE device to perform the steps of: operating (1404) the first UE device to send (via the wireless transmitter) to a first network interface device (303) (e.g., a 3GPP Next Generation-Radio Access Network (NG-RAN) device, e.g., a gNB base station, a non-3GPP Interworking Function (N3IWF) or a Trusted Network Gateway Function (TNGF)) a first message, said first message including an initial registration request message; and operating (1406) the first UE device to receive (via the wireless receiver) (in response to the initial registration request) a registration accept message including a GUAMI of an AMF (221 or 222) identifying an AMF (221 or 222), selected to support first UE device communications sessions, and including AMF path switching capability information indicating the path switching support capability of the identified AMF (i.e., the AMF identified by the GUAMI included in the registration accept message).

Various embodiments are directed to apparatus, e.g., UEs, access points, a device including a AMF, a device including a UDM, a device including a SMF, a device including a PCF, a device including a UPF, a server, a device including a N3IWF, a device including a TNGF, base stations, e.g. sector base stations, such as gNB, ng-eNBs, eNBs, etc. supporting beamforming, UEs, base stations supporting massive MIMO such as CBSDs supporting massive MIMO, network management nodes, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, etc., other network communications devices such as routers, switches, etc., mobile network operator (MNO) base stations (macro cell base stations and small cell base stations) such as a Evolved Node B (eNB), gNB or ng-eNB, mobile virtual network operator (MVNO) base stations such as Citizens Broadband Radio Service Devices (CBSDs), network nodes, MNO and MVNO HSS devices, relay devices, e.g. mobility management entities (MMEs), an AFC system, an Access and Mobility Management Function (AMF) device, servers, customer premises equipment devices, cable systems, network nodes, gateways, cable headend and/or hubsites, network monitoring nodes and/or servers, cluster controllers, cloud nodes, production nodes, cloud services servers and/or network equipment devices. Various embodiments are also directed to methods, e.g., method of controlling and/or operating a UE, an access point, a device including a AMF, a device including a UDM, a device including a SMF, a device including a PCF, a device including a UPF, a server, a device including a N3IWF, a device including a TNGF, a base station, e.g. a sector base station, such as gNB, ng-eNB, eNB, etc., supporting beamforming, UEs, a base station supporting massive MIMO such as a CBSD supporting massive MIMO, a network management node, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, network communications devices such as routers, switches, etc., user devices, base stations, e.g., eNB and CBSDs, gateways, servers (HSS server), MMEs, an AFC system, cable networks, cloud networks, nodes, servers, cloud service servers, customer premises equipment devices, controllers, network monitoring nodes and/or servers and/or cable or network equipment devices. Various embodiments are directed to communications networks which are partners, e.g., a MVNO network and a MNO network. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements are steps are implemented using hardware circuitry.

In various embodiments nodes and/or elements described herein are implemented using one or more components to perform the steps corresponding to one or more methods, for example, message reception, message generation, signal generation, signal processing, sending, comparing, determining and/or transmission steps. Thus, in some embodiments various features are implemented using components or in some embodiment's logic such as for example logic circuits. Such components may be implemented using software, hardware or a combination of software and hardware. Devices can and sometimes are implemented as a set of separate elements or processors which work together to implement the functions attributed to a device. Cloud based processing systems can are used to implement one or more functions of a device in some embodiments.

Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a UE, an access point, a device including a AMF, a device including a UDM, a device including a SMF, a device including a PCF, a device including a UPF, a server, a device including a N3IWF, a device including a TNGF, a base station, e.g. a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, base stations such as NRU gNB base station, etc., a user device such as a station (STA), e.g., WiFi STA, a user equipment (UE) device, LTE LAA device, etc., an RLAN device, other network communications devices a network communications device such as router, switch, etc., a MVNO base station such as a CBRS base station, e.g., a CBSD, a device such as a cellular base station e.g., an eNB, a MNO HSS server, a MVNO HSS server, a UE device, a relay device, e.g. a MME, a AFC system, etc., said device including a processor configured to implement one, multiple or all of the steps of one or more methods of the invention.

In some embodiments, the processor or processors, e.g., CPUs, of one or more devices, e.g., a UE, an access point, a device including a AMF, a device including a UDM, a device including a SMF, a device including a PCF, a device including a UPF, a server, a device including a N3IWF, a device including a TNGF, a base station, e.g. a sector base station, such as gNB, ng-eNB, eNB, etc., supporting beamforming, a UE, a base station supporting massive MIMO such as a CBSD supporting massive MIMO, a network management device, communications nodes such as e.g., access points (APs), e.g., WiFi APs, base stations such as NRU gNB base stations, etc., user devices such as stations (STAs), e.g., WiFi STAs, user equipment (UE) devices, LTE LAA devices, etc., various RLAN devices, network communications devices such as routers, switches, etc., a MVNO base station such as a CBRS base station, e.g. a CBSD, an device such as a cellular base station e.g., an eNB, a MNO HSS server, a MVNO HSS device server, a UE device, a relay device, e.g. a MME, a AFC system, are configured to perform the steps of the methods described as being performed by the communications nodes, e.g., controllers. The configuration of the processor may be achieved by using one or more components, e.g., software components, to control processor configuration and/or by including hardware in the processor, e.g., hardware components, to perform the recited steps and/or control processor configuration.

Accordingly, some but not all embodiments are directed to a device, e.g., a UE, an access point, a device including a AMF, a device including a UDM, a device including a SMF, a device including a PCF, a device including a UPF, a server, a device including a N3IWF, a device including a TNGF, a base station, e.g. a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, a base station such as NRU gNB base station, etc., a user device such as station (STA), e.g., WiFi STA, a user equipment (UE) device, an LTE LAA device, etc., a RLAN device, a network communications device such as router, switch, etc., administrator device, security device, a MVNO base station such as a CBRS base station, e.g. a CBSD, an device such as a cellular base station e.g., an eNB, a MNO HSS server, a MVNO HSS device server, a UE device, a relay device, e.g. a MME, includes a component corresponding to each of one or more of the steps of the various described methods performed by the device in which the processor is included. In some but not all embodiments a device, e.g., a communications node such as UE, an access point, a device including a AMF, a device including a UDM, a device including a SMF, a device including a PCF, a device including a UPF, a server, a device including a N3IWF, a device including a TNGF, base station, e.g. a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, a base station such as NRU gNB base station, etc., a user device such as a station (STA), e.g., WiFi STA, a user equipment (UE) device, a LTE LAA device, a RLAN device, a router, switch, etc., administrator device, security device, a AFC system, a MVNO base station such as a CBRS base station, e.g., a CBSD, a device such as a cellular base station e.g., an eNB, an MNO HSS server, a MVNO HSS device server, a UE device, a relay device, e.g. a MME, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a UE, an access point, a device including a AMF, a device including a UDM, a device including a SMF, a device including a PCF, a device including a UPF, a server, a device including a N3IWF, a device including a TNGF, a base station, e.g., a sector base station, such as gNB, ng-eNB, eNB, etc., supporting beamforming, a UE, a base station supporting massive MIMO such as a CBSD supporting massive MIMO, a network management node or device, a communications device such as a communications nodes such as e.g., a UE, an access point, a device including a AMF, a device including a UDM, a device including a SMF, a device including a PCF, a device including a UPF, a server, a device including a N3IWF, a device including a TNGF, an access point (AP), e.g., WiFi AP, a base station such as NRU gNB base station, etc., a user device such as a station (STA), e.g., WiFi STA, a user equipment (UE) device, a LTE LAA device, etc., an RLAN device, a network communications device such as router, switch, etc., administrator device, MNVO base station, e.g., a CBSD, an MNO cellular base station, e.g., an eNB or a gNB, a UE device or other device described in the present application. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

The methods and procedures used here for UE (102) and PLMN (156) can also be applied for the case where the first path #1 traverses a stand-alone Non-Public Network (SNPN) Core Network (CN), e.g., a network operated by a Non-Public Network (NPN) operator and not relying on network functions provided by a PLMN. In such a case, the SNPN CN is treated like an untrusted WiFi access points (e.g., like, N3GPP access #A 106) since the UE 102 is communicating to N3IWF 114 in the PLMN via the SNPN CN.

The methods and apparatus are well suited for use with N3GPP access networks, both trusted and untrusted and can be used to support MA PDU sessions using such networks in combination with a PLMN.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communications method, the method comprising:
operating a network interface device to receive a first message from a first User Equipment (UE), said first message including an initial registration request message; and
operating the network interface device to send a registration accept message to the first UE including a globally unique AMF identifier (GUAMI) of an Access and Mobility Management Function (AMF) identifying an AMF selected to support first UE communications sessions and including AMF path switching capability information indicating the path switching support capability of the identified AMF.

2. The method of claim 1, wherein the path switching capability information in the registration accept message indicates that the identified AMF does not support path switching of Multi-Access Protocol Data Unit ((MA PDU) sessions between non-3GPP (N3GPP) access paths.

3. The method of claim 2, wherein the path switching capability information in the registration accept message indicates that the identified AMF supports path switching of MA PDU sessions between N3GPP access paths.

4. The method of claim 3, further comprising:
operating the identified AMF to receive an initiate MA PDU session establishment message from the first UE.

5. The method of claim 4, further comprising:
operating the identified AMF to select a session management function session management function (SMF) which supports path switching of MA PDU sessions between N3GPP access paths to be used to support first UE communications.

6. The communications method of claim 5, further comprising:
operating the identified AMF to send a create session management (SM) context request to the selected SMF to create SM context for the first UE at the selected SMF.

7. The method of claim 6, wherein sending the create SM content request is sent by the selected SMF as part of establishing an MA PDU session for the first UE in response to the initiate MA PDU session establishment message received from the first UE.

8. The method of claim 7, further comprising:
operating another network interface device to communicate with the UE via a MA PDU path established in response to the initiate MA PDU session establishment message.

9. A communications system comprising:
a network interface device including:
a first receiver;
a first transmitter; and
a first processor configured to:
operate the network interface device to receive a first message from a first User Equipment (UE), said first message including an initial registration request message; and
operate the network interface device to send a registration accept message to the first UE including a GUAMI of an AMF identifying an AMF selected to support first UE communications sessions and including AMF path switching capability information indicating the path switching support capability of the identified AMF.

10. The communications system of claim 9, wherein the path switching capability information in the registration accept message indicates that the identified AMF does not support path switching of MA PDU sessions between N3GPP access paths.

11. The communications system of claim 10, wherein the path switching capability information in the registration accept message indicates that the identified AMF supports path switching of MA PDU sessions between N3GPP access paths.

12. The communications system of claim 11, further comprising:
said identified AMF including:
a second receiver; and
a second processor configured to:
operate the identified AMF to receive an initiate MA PDU session establishment message from the first UE.

13. The communications system of claim 12, wherein said second processor is further configured to:
operate the identified AMF to select a SMF which supports path switching of MA PDU sessions between N3GPP access paths to be used to support first UE communications.

14. The communications system of claim 13, wherein said identified AMF further includes a second transmitter; and
wherein said second processor is further configured to:
operate the identified AMF to send a create session management (SM) context request to the selected SMF to create SM context for the first UE at the selected SMF.

15. The communications system of claim 14, wherein sending the create SM content request is sent by the selected SMF as part of establishing an MA PDU session for the first UE in response to the initiate MA PDU session establishment message received from the first UE.

16. A method of operating a first user equipment (UE) device, the method comprising:
operating the first UE device to send to a first network interface device a first message, said first message including an initial registration request message; and
operating the first UE device to receive a registration accept message including a GUAMI of an AMF identifying an AMF, selected to support first UE device communications sessions, and including AMF path switching capability information indicating the path switching support capability of the identified AMF.

17. The method of claim 16, wherein said initial registration request message includes path switching capability information indicating whether the first UE device supports path switching of MA PDU sessions between N3GPP access paths.

18. The method of claim 16, wherein said first network interface device is a 3GPP Next Generation-Radio Access Network (NG-RAN) device, e.g., a gNB base station.

19. The method of claim 16, wherein said first network interface device is a non-3GPP Interworking Function (N3IWF).

20. The method of claim 16, wherein said first network interface device is a Trusted Network Gateway Function (TNGF)).

21. The method of claim 16, wherein said AMF path switching capability information is communicated via a mandatory field.

22. The method of claim 16, wherein the path switching capability information in the registration accept message indicates that the identified AMF does not support path switching of MA PDU sessions between N3GPP access paths.

23. The method of claim 16, wherein the path switching capability information in the registration accept message indicates that the identified AMF supports path switching of MA PDU sessions between N3GPP access paths.

24. The method of claim 23, wherein said initial registration request message includes path switching capability information indicating whether the first UE device supports path switching of MA PDU sessions between N3GPP access paths.

25. The method of claim 23, further comprising:
operating the first UE device to participate in a first MA PDU session, said participating including communications via a first path, said first path including a first N3GPP access device;
operating the first UE device to perform a path switch of the first MA PDU session from the first path to a second path, said second path including a second N3GPP access device; and
operating the first UE device to continue participating in the first MA PDU session, said continuing participating in the first MA PDU session including communications via the second path.

26. A first user equipment (UE) device comprising:
a wireless transmitter;
a wireless receiver; and
a processor configured to:
operate the first UE device to send to a first network interface device a first message, said first message including an initial registration request message; and
operate the first UE device to receive a registration accept message including a GUAMI of an AMF identifying an AMF, selected to support first UE device communications sessions, and including AMF path switching capability information indicating the path switching support capability of the identified AMF.

27. The first UE device of claim 26, wherein said initial registration request message includes path switching capability information indicating whether the first UE device supports path switching of MA PDU sessions between N3GPP access paths.

28. The first UE device of claim 26, wherein the path switching capability information in the registration accept message indicates that the identified AMF supports path switching of MA PDU sessions between N3GPP access paths.

29. The UE device of claim 28, wherein said initial registration request message includes path switching capability information indicating whether the first UE device supports path switching of MA PDU sessions between N3GPP access paths.

30. The first UE device of claim 28, wherein said processor is further configured to:
operate the first UE device to participate in a first MA PDU session, said participating including communications via a first path (first access path), said first path including a first N3GPP access device;
operate the first UE device to perform a path switch of the first MA PDU session from the first path to a second path, said second path including a second N3GPP access device; and
operating the first UE device to continue participating in the first MA PDU session, said continuing participating in the first MA PDU session including communications via the second path.
